(19) United States
(12) Patent Application Publication
(10) Pub. No.: US 2024/0153263 A1
(43) Pub. Date: May 9, 2024

(54) INFORMATION PROCESSING SYSTEM, INFORMATION PROCESSING APPARATUS, INFORMATION PROCESSING METHOD, AND RECORDING MEDIUM

(71) Applicant: NEC Corporation, Minato-ku, Tokyo (JP)

(72) Inventors: Hirokazu AKIBA, Tokyo (JP); Shinji OOMINATO, Tokyo (JP); Yifeng ZHOU, Tokyo (JP)

(73) Assignee: NEC Corporation, Minato-ku, Tokyo (JP)

(21) Appl. No.: 17/776,338

(22) PCT Filed: Sep. 30, 2021
(86) PCT No.: PCT/JP2021/036180

§ 371 Date: May 12, 2022

(51) Int. Cl. G06V 10/98; G06V 10/141; G06V 40/16; G06V 40/18; G06V 40/19; G06V 40/40; G06V 40/50; G06V 40/60; G06V 40/70

(52) U.S. Cl. CPC G06V 10/993; G06V 10/141; G06V 40/172; G06V 40/19; G06V 40/197; G06V 40/40; G06V 40/50; G06V 40/67; G06V 40/70

(57) ABSTRACT

An information processing system (10) comprises: an image acquisition unit (110) that acquires a face image and an iris image with respect to a registration target; a score computing unit (120) that calculates a quality-score indicating quality with respect to each of the face image and the iris image; and a selection unit (130) that selects each of the face image and the iris image for registration based on the quality-score. According to this information processing system, it is possible to register high-quality face image and iris image.

### TECHNICAL FIELD

The disclosure relates to technical fields of an information processing system, an information processing apparatus, an information processing method, and a recording medium.

### BACKGROUND ART

There is known as this type of system a system for evaluating the quality of image used in biometric authentication. For example, Patent Document 1 discloses that the best eyes image evaluated among a plurality of eyes image in an eyes image evaluation unit is stored as registered authentication information. In Patent Document 2, it is disclosed that, when a face area or an eyes area cannot be extracted from an image, False is returned as imaging quality, and when both the face area and the eyes area can be extracted, True is returned as imaging quality. Patent Document 3 discloses that an image including at least eyes of an authentication target is taken repeatedly and the image whose quality is determined to be good by an image quality determination unit is outputted.

### PRIOR ART DOCUMENT LIST

### Patent Document

Patent Document 1: JP 2007-159610 A
Patent Document 2: JP 2019-191898 A
Patent Document 3: JP 2006-163683 A

### SUMMARY

### Technical Problem

This disclosure aims to improve the techniques disclosed in the Prior Art Documents.

### Solution to Problem

One aspect of the information processing system disclosed here comprises: an image acquisition unit that acquires a face image and an iris image with respect to a registration target; a score computing unit that calculates a quality-score indicating quality with respect to each of the face image and the iris image; and a selection unit that selects each of the face image and the iris image for registration based on the quality-score.

One aspect of the information processing apparatus disclosed here comprises: an image acquisition unit that acquires a face image and an iris image with respect to a registration target; a score computing unit that calculates a quality-score indicating quality with respect to each of the face image and the iris image; and a selection unit that selects each of the face image and the iris image for registration based on the quality-score.

One aspect of the information processing method disclosed here is an information processing method executed by at least one computer, comprising: acquiring a face image and an iris image with respect to a registration target; calculating a quality-score indicating quality with respect to each of the face image and the iris image; and selecting each of the face image and the iris image for registration based on the quality-score.

One aspect of the recording medium disclosed here is a recording medium storing a computer program that allows at least one computer to execute an information processing method, the information processing method comprising: acquiring a face image and an iris image with respect to a registration target; calculating a quality-score indicating quality with respect to each of the face image and the iris image; and selecting each of the face image and the iris image for registration based on the quality-score.

### BRIEF DESCRIPTION OF DRAWINGS

FIG. 1 A block diagram showing a hardware configuration of the information processing system according to the first example embodiment.

FIG. 2 A perspective view showing a configuration of a authentication terminal provided by the information processing system according to the first example embodiment.

FIG. 3 A block diagram showing a functional configuration of the information processing system according to the first example embodiment.

FIG. 4 A block diagram showing a functional configuration of a modification of the information processing system according to the first example embodiment.

FIG. 5 A flowchart showing a flow of registration operation by the information processing system according to the first example embodiment.

FIG. 6 A flowchart showing a flow of imaging operation by the information processing system according to the first example embodiment.

FIG. 7 A block diagram showing a functional configuration of the information processing system according to the second example embodiment.

FIG. 8 A flowchart showing a flow of registration operation by the information processing system according to the second example embodiment.

FIG. 9 A block diagram showing a functional configuration of the information processing system according to the third example embodiment.

FIG. 10 A flowchart showing a flow of authentication operation by the information processing system according to the third example embodiment.

FIG. 11 A plan view showing an example of sequential display by the information processing system according to the third example embodiment.

FIG. 12 A block diagram showing a functional configuration of an information processing system according to the fourth example embodiment.

FIG. 13 A flowchart showing a flow of iris imaging operation by the information processing system according to the fourth example embodiment.

FIG. 14 A block diagram showing a functional configuration of the information processing system according to a fifth example embodiment.

FIG. 15 A flowchart showing a flow of authentication operation by the information processing system according to the fifth example embodiment.

FIG. 16 A block diagram showing a functional configuration of the information processing system according to the sixth example embodiment.

FIG. 17 A flowchart showing a flow of authentication operation by the information processing system according to the sixth example embodiment.

FIG. 18 A block diagram showing a functional configuration of the information processing system according to the seventh example embodiment.

FIG. 19A A plan view showing a specific example of authentication operation by the information processing system according to the eighth example embodiment.

FIG. 19B A plan view showing a specific example of authentication operation by the information processing system according to the eighth example embodiment.

FIG. 20 A block diagram showing a functional configuration of the information processing system according to the ninth example embodiment.

FIG. 21 A plan view (Part 1) showing a display example in the information processing system according to the ninth example embodiment.

FIG. 22 A plan view (Part 2) showing a display example in the information processing system according to the ninth example embodiment.

FIG. 23 A block diagram showing a functional configuration of the information processing system according to the tenth example embodiment.

FIG. 24 A flowchart showing a flow of operation by a first registration control unit of the information processing system according to the tenth example embodiment.

FIG. 25 A flowchart showing a flow of operation by a second registration control unit of the information processing system according to the tenth example embodiment.

FIG. 26 A block diagram showing a functional configuration of the information processing system according to the eleventh example embodiment.

FIG. 27 A plan view showing an example of impersonation detection operation by the information processing system according to the eleventh example embodiment.

FIG. 28 A block diagram showing a functional configuration of the information processing system according to the twelfth example embodiment.

FIG. 29 A flowchart showing a flow of authentication method determination operation by the information processing system according to the twelfth example embodiment.

FIG. 30 A block diagram showing a functional configuration of the information processing system according to the thirteenth example embodiment.

FIG. 31 A block diagram showing a functional configuration of the information processing system according to the fourteenth example embodiment.

### DESCRIPTION OF EXAMPLE EMBODIMENTS

Hereinafter, an example embodiment of an information processing system, an information processing apparatus, an information processing method, and a recording medium will be described with reference to the drawings.

### First Example Embodiment

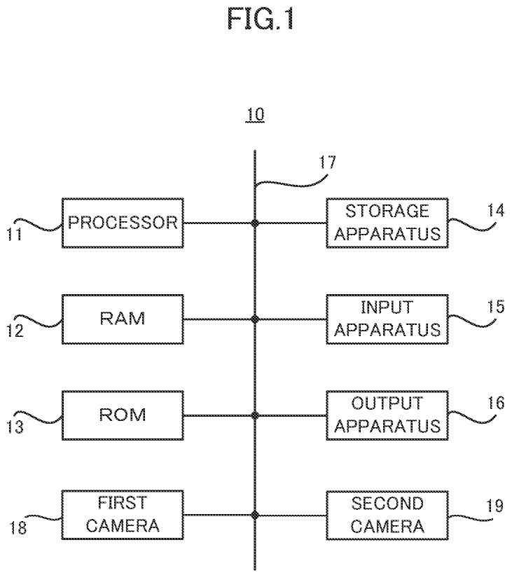

The information processing system according to a first example embodiment will be described with reference to FIGS. 1 to 6.

### (Hardware Configuration)

First, a hardware configuration of the information processing system according to the first example embodiment will be described with reference to FIG. 1. FIG. 1 is a block diagram showing the hardware configuration of the information processing system according to the first example embodiment.

As shown in FIG. 1, the information processing system 10 according to the first example embodiment comprises a processor 11, a RAM (Random Access Memory) 12, a ROM (Read Only Memory) 13, and a storage apparatus 14. The information processing system 10 may further comprise an input apparatus 15 and an output apparatus 16. The information processing system 10 may also comprise a first camera 18 and a second camera 19. The processor 11 described above, the RAM12, the ROM13, the storage apparatus 14, the input apparatus 15, the output apparatus 16, the first camera 18, and the second camera 19 are connected with each other via a data bus 17.

The Processor 11 reads a computer program. For example, the processor 11 is configured to read a computer program stored in at least one of the RAM12, the ROM13 and the storage apparatus 14. Alternatively, the processor 11 may read a computer program stored in a computer readable recording medium using a recording medium reading apparatus (not illustrated). The processor 11 may acquire (i.e. read) a computer program from an apparatus (not illustrated) located external to the information processing system 10 via a network interface. The processor 11 controls the RAM12, the storage apparatus 14, the input apparatus 15, and the output apparatus 16 by executing the computer program read. In particular, in the present example embodiment, when the computer program read by the processor 11 is executed, realized in the processor 11 are functional blocks for acquiring an image of a target to execute biometric authentication. That is, the processor 11 may function as a controller that executes each control of the information processing system 10.

The processor 11 may be configured as, for example, a CPU (Central Processing Unit), a GPU (Graphics Processing Unit), FPGA (field-programmable gate array), a DSP (Demand-Side Platform), and a ASIC (Application Specific Integrated Circuit. The processor 11 may be configured as one of these, or may be configured to use two or more of them in parallel.

The RAM12 temporarily stores the computer program which the processor 11 executes. The RAM12 temporarily stores data which the processor 11 temporarily uses when being executing a computer program. The RAM12 may be, for example, a D-RAM (Dynamic RAM).

The ROM13 stores the computer program to be executed by the processor 11. The ROM13 may further store fixed data. The ROM13 may be, for example, a P-ROM (Programmable ROM).

The storage apparatus 14 stores data that the information processing system 10 should preserve over a long period of time. The storage apparatus 14 may operate as a temporary storage apparatus of the processor 11. The storage apparatus 14 may include, for example, at least one of a hard disk apparatus, a magnet-optical disk apparatus, an SSD (Solid State Drive), and a disk array apparatus.

The input apparatus 15 is an apparatus that receives input instructions from a user of the information processing system 10. The input apparatus 15 may include, for example, at least one of a keyboard, a mouse, and a touch panel. The input apparatus 15 may be configured as a portable terminal, such as a smartphone or tablet.

The output apparatus 16 is an apparatus that outputs information relating to the information processing system 10 to the outside. For example, the output apparatus 16 may be a display apparatus (e.g. a display) capable of displaying information relating to the information processing system 10. Further, the output apparatus 16 may be a speaker or the like capable of audio output relating to the information processing system 10. The output apparatus 16 may be configured as a portable terminal, such as a smartphone or tablet.

The first camera 18 and the second camera 19 are each a camera installed in a position capable of taking an image of a target. The target here is not limited to a human, and may include an animal such as a dog or snake, a robot, and the like. The first camera 18 and the second camera 19 may each be configured as a camera which images a different part of the target from each other. For example, the first camera 18 may be configured to take an image including a face of the target (hereinafter, referred to as the “face image”), while the second camera 19 may be configured to take an image including an iris of the target (hereinafter, referred to as the “iris image”). The first camera 18 and the second camera 19 may be each a camera for taking still images or a camera for taking moving images. The first camera 18 and the second camera 19 may be each configured as a visible light camera, or a near-infrared camera. Further, the first camera 18 and the second camera 19 may be each configured as a depth camera, or a thermo-camera. The first camera 18 and the second camera 19 may each include a plurality of pieces. The first camera 18 and the second camera may be configured as a single common camera. The first camera 18 and the second camera 19 may be each a camera mounted on a terminal owned by the target (e.g. the smartphone). The first camera 18 and the second camera 19 may be provided with a function such that the power becomes off automatically when no image is taken. In this case, the power-off may be performed to parts having short life-span such as a liquid lens and a motor in priority. Hereinafter, the description will be given of an example that the first camera 18 is configured as a face camera for taking the face image and the second camera 19 is configured as a iris camera for taking the iris image (hereinafter, to the face camera which is one example of the first camera 18 and the iris camera which is one example of the second camera 19, the common reference signs are given like “the face camera 18” and “the iris camera 19”, respectively.

In FIG. 1, an example of the information processing system 10 configured to include a plurality of apparatuses has been exemplified, but all or part of their functions may be realized by one apparatus (the information processing apparatus). The information processing apparatus may be configured with, for example, only the processor 11, the RAM12, and the ROM13 described above. With respect to the other components (i.e. the storage apparatus 14, the input apparatus 15, the output apparatus 16, the face camera 18, and the iris camera 19), an external apparatus connected to, for example, the information processing apparatus may comprise them.

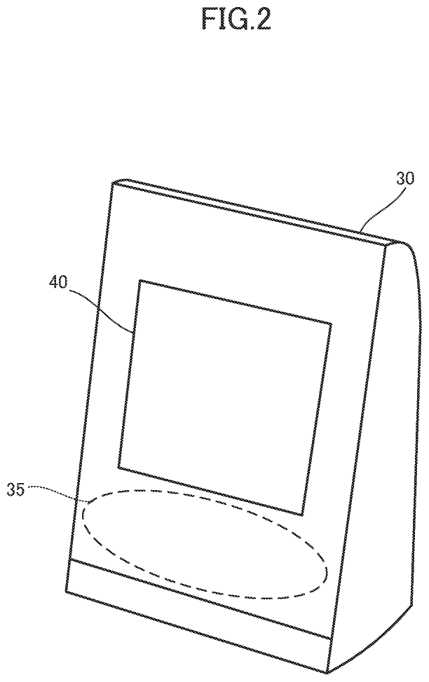

In addition, the information processing apparatus may realize a part of the arithmetic functions by an external apparatus (e.g. an external server, or a cloud system, etc.). (Configuration of Authentication Terminal) Next, a configuration of an authentication terminal provided in the information processing system 10 according to the first example embodiment will be described with reference to FIG. 2. FIG. 2 is a perspective view showing the configuration of the authentication terminal provided by the information processing system according to the first example embodiment.

As shown in FIG. 2, the information processing system 10 according to the first example embodiment is configured so as to comprise the authentication terminal 30 including the face camera (that is, the first camera 18) and the iris camera (that is, the second camera 19), both having been described above. The housing of the authentication terminal 30 is constituted by, for example, a resin, metal, or the like. The front part of the authentication terminal 30 is provided with a display 40. This display 40 may display various information relating to the authentication terminal 30, messages to a user, and images or videos taken by the face camera 18 and the iris camera 19. There is a camera installation portion 35 located in the lower portion of the display (the portion surrounded by the broken line in the drawing). In the camera installation portion 35, the face camera 18 and the iris camera 19 are installed. The face camera 18 and the iris camera 19 may be installed so as to be visible from the outside of the housing, or may be installed so as not to be seen from the outside. For example, in a case that the first camera 18 and the second camera 19 are each configured as a visible light camera, the visible light camera, in order to take in external visible light, may be installed so as to be exposed to the outside (e.g. an opening portion may be provided in the vicinity of the visible light camera.) In a case that the first camera 18 and the second camera 19 are each configured as a near-infrared camera, the near-infrared camera may be installed so as not to be exposed to the outside (e.g. the camera may be covered with a visible light cut film or the like). Further, in a case that the first camera 18 is configured as a visible light camera and the second camera 19 is configured as a near-infrared camera, the first camera 18 may be installed so as to be exposed to the outside (e.g. by providing the opening portion in the vicinity of the first camera 18, etc.), and the second camera 19 may be installed so as not to be exposed to the outside (e.g. the camera may be covered with a visible light cut film or the like).

### (Functional Configuration)

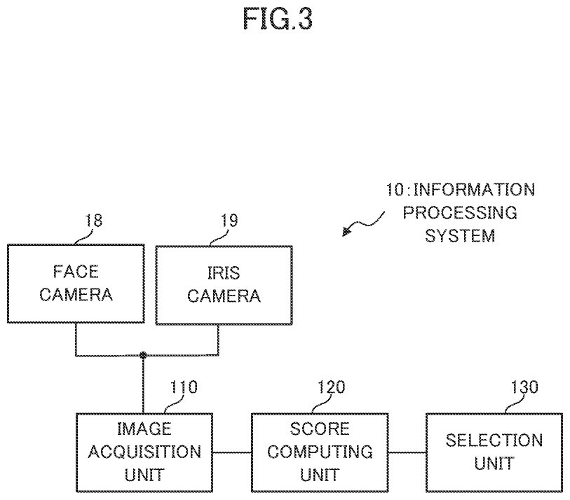

Next, a functional configuration of the information processing system 10 according to the first example embodiment will be described with reference to FIG. 3. FIG. 3 is a block diagram showing the functional configuration of the information processing system according to the first example embodiment.

The information processing system 10 according to the first example embodiment is configured as a system capable of executing processing related to biometric authentication (particularly, facial authentication and iris authentication). The information processing system 10 may be configured as a system for registering, for example, a registered image (i.e. an image of the registered user to be registered in advance) which is used for the biometric authentication. Further, the information processing system 10 may be configured as a system for executing authentication processing. The information processing system 10 may be installed, for example, in a facility or the like that performs the biometric authentication. For example, the information processing system 10 may be installed to a residential facility such as an apartment; a store facility such as a retail store; an office of a company; an airport; a bus terminal; an event space; or the like. The facility is not limited to indoor one only and may include an outdoor one.

As shown in FIG. 3, the information processing system 10 according to the first example embodiment comprises, as a component for realizing functions thereof, the face camera 18 that is an example of the first camera 18 and the iris camera 19 that is an example of the second camera 19 both having been described, an image acquisition unit 110, a score computing unit 120, and a selection unit 130. Each of the image acquisition unit 110, the score computing unit 120, and the selection unit 130 may be a processing block executed, for example, by the processor 11 described above (see FIG. 1).

The image acquisition unit 110 is configured so as to acquire the face image taken by the face camera 18 and the iris image taken by the iris camera 19. The image acquisition unit 110 may be configured so as to acquire the iris image and face image as candidates for the registered images used in the biometric authentication. Specifically, the image acquisition unit 110 may be configured so as to acquire the face image and the iris image with respect to the user (hereinafter, referred to as the “registration target” as appropriate) who intends to register living body information (here, the face information and the iris information). Further, the image acquisition unit 110 may be configured so as to acquire the iris image and the face image each as an image for authentication to be used for the biometric authentication (i.e. an image acquired at the moment of performing the authentication). Specifically, the image acquisition unit 110 may be configured so as to acquire the face image and the iris image with respect to a user (hereinafter, referred to as the “authentication target” as appropriate) intending to perform the biometric authentication (here, the facial authentication and the iris authentication).

The score computing unit 120 is configured so as to calculate a quality-score indicating the quality of the face image and iris image, which are the candidates for the registered images, acquired by the image acquisition unit 110. The score computing unit 120 may calculate the quality-score in consideration of more than one factor that could affect the biometric authentication. For example, the score computing unit 120 may calculate the quality-score based on image blur, eyes orientation, face orientation, eyes opening degree, iris hiding degree, brightness, shadow condition, light hitting condition, etc. In a case that more than one image is acquired by the image acquisition unit 110, the score computing unit 120 may calculate the quality-score for each of the more than one image acquired. In this case, the score computing unit 120 may compare the acquired images to each other to calculate the quality-score. That is, the score computing unit 120 may be configured to calculate a score indicating a relative quality. In a case of comparing the images, the score computing unit 120 may not calculate the quality-score, but may select an image with the best quality among the images (e.g. image with the least blur so that the iris is captured well). For example, when comparing three images, the score computing unit 120 may first compare the first image to the second image to select the image having higher quality, and then compare the selected image to the third image so as to select the image having the highest quality. The quality-score calculated by the score computing unit 120 is configured to be outputted to the selection unit 130.

The selection unit 130 selects the face image and the iris image each being to be registered as the registered images, based on the quality-score calculated by the score computing unit 120. The selection unit 130 may select, for example, among more than one image for which the score has been calculated, one image whose quality-score is the highest. Alternatively, the selection unit 130 may select the one whose quality-score is equal to or greater than a threshold preset in advance. When selecting the image to be registered, the selection unit 130 may output an instruction to the image acquisition unit 110 so as not to acquire any more images. Alternatively, when selecting the image to be registered, the selection unit 130 may output an instruction to the face camera 18 and the iris camera 19 so as not to take any more images.

### (Modification)

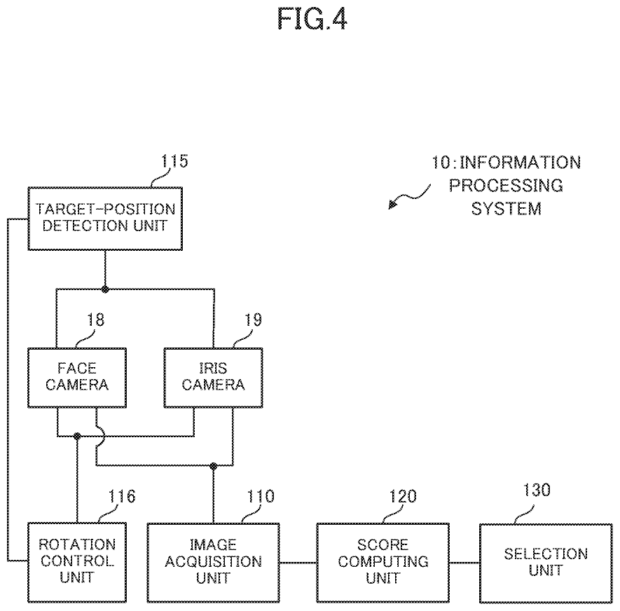

Referring now to FIG. 4, a modification of the information processing system 10 according to the first example embodiment will be described. FIG. 4 is a block diagram showing a functional configuration of the modification of the information processing system according to the first example embodiment. In FIG. 4, the reference signs same as in FIG. 3 are given to the components similar to in FIG. 3 respectively.

As shown in FIG. 4, the modification of the information processing system 10 according to the first example embodiment is configured to comprise the face camera 18, the iris camera 19, the image acquisition unit 110, a target position detection unit 115, a rotation control unit 116, the score computing unit 120, and the selection unit 130 as components for realizing functions thereof. That is, the information processing system 10 according to the modification further comprises, in addition to the configuration of the first example embodiment (see FIG. 3), the target position detection unit 115 and the rotation control unit 116. Each of the target position detection unit 115 and the rotation control unit 116 may be a processing block executed by, for example, the processor 11 described above (see FIG. 1).

The target position detection unit 115 acquires the images taken by the face camera 18 and the iris camera 19 and is configured so as to detect from at least one of the images, the position of the user imaged (hereinafter, appropriately referred to as the “target position”). The target position may be, for example, a position where a face of the target exists, or a position where eyes of the target exist. The target position may be not only a position with respect to the height direction, but also a position with respect to the depth direction corresponding to the distance to the camera, or a position with respect to the lateral direction.

The rotation control unit 116 is configured so as to perform the rotational control of the face camera 18 and the iris camera 19 based on the target position detected by the target position detection unit 115. The rotational control of the face camera 18 and the iris camera 19 may be executed, for example, by a motor or the like. Also, the face camera 18 and the iris camera 19 may be controlled to rotate about a common rotation axis. The rotation control unit 116 determines, for example, the rotation direction and the rotation amount with respect to the face camera 18 and the iris camera 19, and is configured so as to execute control according to parameters determined. Specifically, the rotation control unit 116 controls the rotational operation with respect to the face camera 18 and the iris camera 19 so that the user's face and iris can be taken by each of the face camera 18 and the iris camera 19 (in other words, the user's face and iris can be included in the imaging range of each of the face camera 18 and the iris camera 19).

With respect to the face camera 18 and the iris camera 19, the imaging range of each camera sometimes differs from each other (for example, the imaging range of the face camera is wider). In such a case, the rotation may be controlled so that, first, the target position is detected by the face camera 18 whose imaging range is wide, and then the iris is imaged by the iris camera 19 whose imaging range is narrow.

The position detection by the target position detection unit 115 and the rotational operation by the rotation control unit 116 may be executed in parallel with each other at the same time. In this case, while the target is being imaged by the first camera 18 and the second camera 19, the target position may be detected, and at the same time, the rotational operation based on the detected position may be performed.

### (Registration Operation)

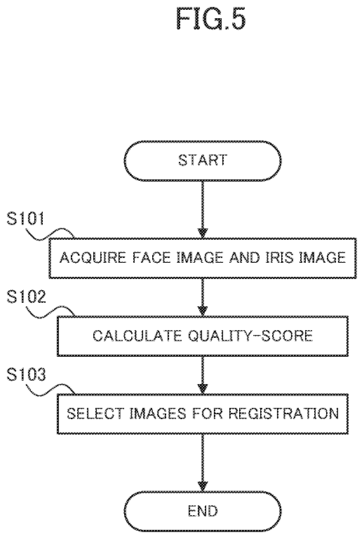

Next, referring to FIG. 5, a flow of operation of registering the image to be used for the authentication by the information processing system 10 according to the first example embodiment (hereinafter, appropriately referred to as “registration operation”) will be described. FIG. 5 is a flowchart showing the flow of the registration operation by the information processing system according to the first example embodiment.

As shown in FIG. 5, when the registration operation by the information processing system 10 according to the first example embodiment is started, first, the image acquisition unit 110 acquires the face image and the iris image with respect to the registration target (step S110). The face image and the iris image may be taken at the same time, or they may be taken at different timing from each other.

The score computing unit 120 then calculates the quality-scores with respect to the face image and the iris image, each having been acquired at the image acquisition unit 110 (step S102). Then, the selection unit 130 selects the face image and the iris image each being to be registered, based on the quality-score calculated in the score computing unit 120 (step S103).

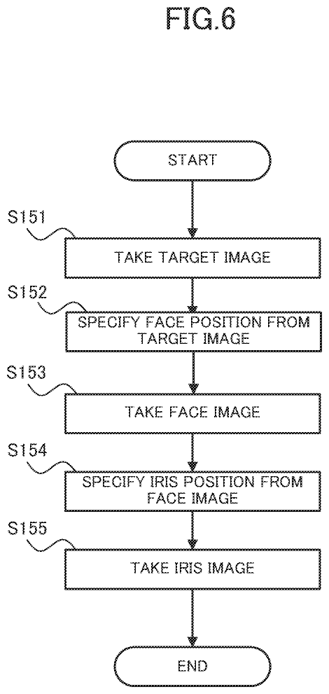

In the above-described example, the face image and the iris image are registered at the same time, but the face image and the iris image may be registered separately from each other. For example, you may acquire the face images and select the face image to be registered, then acquire the iris images and select the iris image to be registered. In the following, an example of operation executed when the face image and the iris image are taken (hereinafter, referred to as “imaging operation” as appropriate) will be described with reference to FIG. 6. FIG. 6 is a flowchart showing the flow of the imaging operation by the information processing system according to the first example embodiment.

As shown in FIG. 6, when the imaging operation by the information processing system 10 according to the first example embodiment is started, first, the face camera 18 takes the image of the target (step S151). The image of target may be, for example, an image including a whole body of the target or an image including an upper body of the target. Then, a face detector specifies the position of the face of the target from the image of the target (step S152). The face detector is capable of detecting the position of the face of the target (for example, the position of area including the face of the target). The face detector may be configured as the one provided by the image acquisition unit 110 (that is, one function of the image acquisition unit 110). The face camera 18 then takes the face image of the target based on the specified position of the face of the target (step S153). The face camera 18 may take the face image at a timing, for example, when the face position of the target is included in the imaging range.

Subsequently, an iris detector detects the position of the target from the face image (step S154). The iris detector is capable of detecting the position of the iris of the target (e.g. the position of area including the iris of the target). The iris detector may be configured as the one provided by the image acquisition unit 110 (that is, one function of the image acquisition unit 110). Thereafter, the iris camera 19 takes the iris image of the target based on the specified position of the iris of the target (step S155). The iris camera 19 may take the iris image at a timing, for example, when the iris position is included in the imaging range or when the iris overlaps the focus position.

### (Technical Effects)

Next, technical effects obtained by the information processing system 10 according to the first example embodiment will be described.

As described in FIGS. 1 to 6, in the information processing system 10 according to the first example embodiment, the face image and the iris image each being to be registered are selected based on the quality-score. By this way, it is possible to register high-quality face image and iris image. Consequently, for example, it is possible to improve authentication accuracy with respect to the facial authentication and the iris authentication.

### Second Example Embodiment

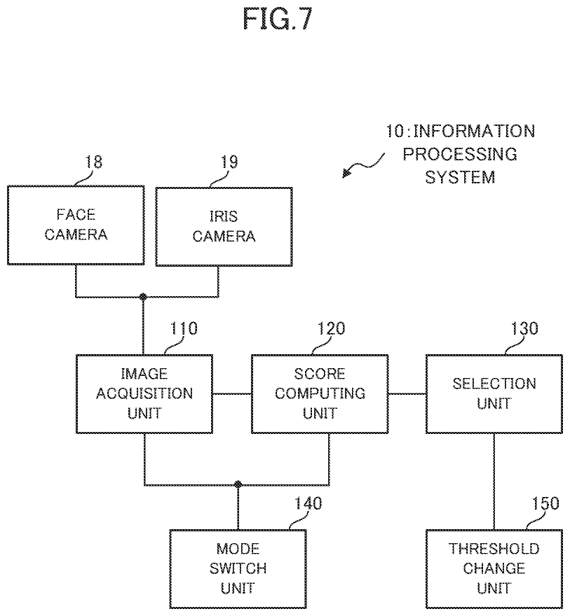

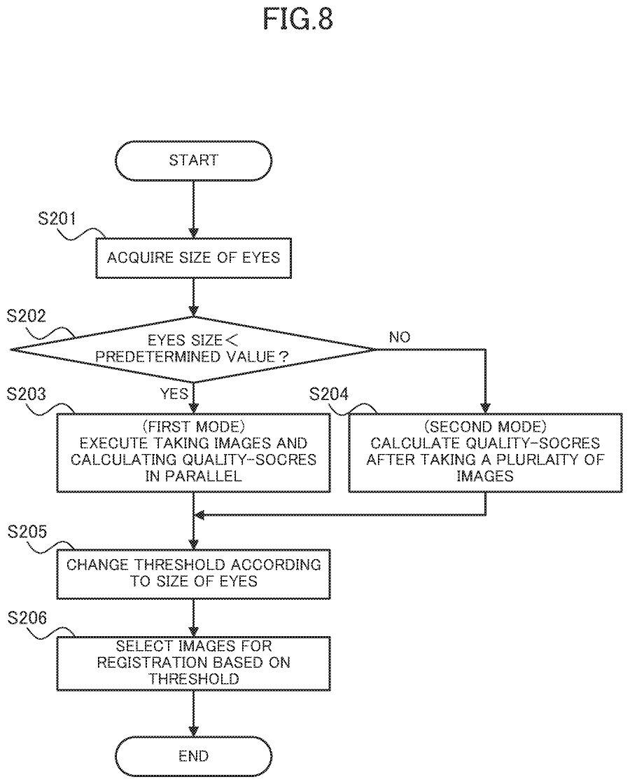

The information processing system 10 according to a second example embodiment will be described with reference to FIGS. 7 and 8. The second example embodiment differs from the first example embodiment described above only in a part of configuration and operations, and the other parts may be the same as those in the first example embodiment. Therefore, the part that differs from the first example embodiment described above will be described in detail below, and the other overlapping parts will not be described as appropriate.

### (Functional Configuration)

First, a functional configuration of the information processing system 10 according to the second example embodiment will be described with reference to FIG. 7. FIG. 7 is a block diagram showing the functional configuration of the information processing system according to the second example embodiment. In FIG. 7, the reference signs same as in FIG. 3 are given to the components similar to in FIG. 3 respectively.

As shown in FIG. 7, the information processing system 10 according to the second example embodiment is configured to comprise the face camera 18, the iris camera 19, the image acquisition unit 110, the score computing unit 120, the selection unit 130, a mode switch unit 140, and a threshold change unit 150 as components for realizing the functions thereof. That is, the information processing system 10 according to the second example embodiment further comprises, in addition to the configuration of the first example embodiment (see FIG. 3), the mode switch unit 140, and the threshold change unit 150. Each of the mode switch unit 140 and the threshold change unit 150 may be a processing block implemented by, for example, the processor 11 described above (see FIG. 1).

The mode switch unit 140 is configured so as to switch a mode of the registration operation. Specifically, the mode switch unit 140 is configured so as to switch between a first mode where the imaging of the face image and the iris image is executed in parallel with the calculation of the quality-scores, and a second mode where the calculation of the quality-scores is executed after the imaging of the face image and the iris image. The mode switch unit 140 switches between the first mode and the second mode based on the size of eyes of the registration target. Alternatively, the mode switch unit 140 may switch between the first mode and the second mode based on the condition of captured iris (for example, whether or not the iris is hidden in the eyelid, or whether or not the iris is hidden because of reflection of illumination, etc.). For example, the mode switch unit 140 may switch the mode to the first mode when the eyes of the registration target is relatively small, and switch the mode to the second mode when the eyes of the registration target is relatively large. In this case, the mode switch unit 140 may switch between the first mode and the second mode using a threshold set in advance with respect to the size of eyes.

The threshold change unit 150 is configured so as to change a threshold which is used when the face image and the iris image to be registered are selected by the selection unit 130. The threshold change unit 150 may be configured so as to, for example, increase the threshold as the eyes of the registration target get larger. In this case, the threshold becomes high in a case that the eyes of the registration target are large. Therefore, with respect to the registration target having large eyes, the face image and iris image to be registered are less likely to be selected. On the other hand, the threshold becomes low in a case that the eyes of the registration target are small. Therefore, with respect to the registration target having smaller eyes, the face image and iris image to be registered are easily selected. Further, the threshold change unit 150 may be configured so as to, for example, lower the threshold as the eyes of the registration target get larger. In this case, though the threshold becomes low in a case that the registration target has large eyes, with respect to the registration target having large eyes, it is likely to acquire a high-quality image. Accordingly, even if the threshold is lowered (in other words, even if there is some blur or illumination appears in the iris), it is possible to register an appropriate image. On the other hand, the threshold becomes high in a case that the registration target has small eyes. Therefore, with respect to the registration target having small eyes, it is possible to acquire a higher-quality image (e.g. by retake of many times, it is possible to acquire a high-quality image). The threshold change unit 150 may be configured to change the threshold based on the condition of imaged iris. For example, the threshold change unit 150 may increase the threshold as the condition of imaged iris gets better. Alternatively, the threshold change unit 150 may lower the threshold as the condition of imaged iris gets better. Further, the threshold change unit 150 may have a function of detecting eyeglasses or color contacts, and change the threshold according to the detection result. For example, when the eyeglasses or the color contacts are detected, the threshold may be set higher compared to a case when they are not detected (for example, when there are eyeglasses, the image may be taken many times compared to the case that there are no eyeglasses).

### (Registration Operation)

Next, referring to FIG. 8, a description will be given of a flow of the registration operation by the information processing system 10 according to the second example embodiment. FIG. 8 is a flowchart showing the flow of the registration operation by the information processing system according to the second example embodiment. In FIG. 8, the reference signs same as in FIG. 5 are given to the processes similar to in FIG. 5 respectively.

As shown in FIG. 8, when the registration operation by the information processing system 10 according to the second example embodiment is started, first the size of eyes of the registration target is acquired (step S201). The size of eyes may be acquired from, for example, the image of the registration target (e.g. the face image or the iris image). Thereafter, the mode switch unit 140 determines whether or not the size of the eyes is smaller than a predetermined value (step S202).

If the size of the eyes is smaller than the predetermined value (step S202: YES), the mode switch unit 140 performs switching to the first mode (step S203). In other words, the mode is switched to the mode in which the taking of the face image and iris image and the calculation of the quality-score are executed in parallel. On the other hand, when the size of the eyes is larger than the predetermined value (step S202: NO), the mode switch unit 140 performs switching to the second mode (step S204). In other words, the mode is switched to the mode in which the quality-score calculation is executed after the taking of the face image and iris image.

Subsequently, the threshold value change unit 150 changes the threshold which is used by the selection unit 130, according to the size of eyes of the registration target (step S205). Then, the selection unit 130 selects the face image and iris image to be registered using the threshold changed (step S206).

### (Technical Effects)

Next, technical effects obtained by the information processing system 10 according to the second example embodiment will be described.

As described in FIGS. 7 and 8, in the information processing system 10 according to the second example embodiment, the switching of the mode of the registration operation and the change of the threshold are performed on the basis of the size of eyes. Here, in particular, with respect to the registration target having small eyes, it is difficult to acquire an image whose quality-score is high. Therefore, by performing the registration operation in the first mode, it is possible to acquire more appropriately an image whose quality-score is high. For example, by repeating the imaging until an image whose quality-score is high is acquired, it is possible to acquire the image whose quality-score is high. Further, with respect to the registration target having small eyes, the threshold is changed to get lower. Thereby, even if it is difficult to acquire an image whose quality-score is high, the face image and iris image to be registered could be selected more easily. On the other hand, with respect to the registration target having large eyes, an image whose quality-score is high could be acquired easily. Therefore, by performing the registration operation in the second mode, it is possible to perform the registration operation more efficiently. For example, if the face image and iris image are previously taken, it is possible to shorten the time required for the imaging (i.e. the time required for making the registration target wait in front of the cameras). Further, with respect to the registration target having large eyes, by changing the threshold to make it higher, it becomes possible to acquire the face image and iris image each having a high quality-score.

### Third Example Embodiment

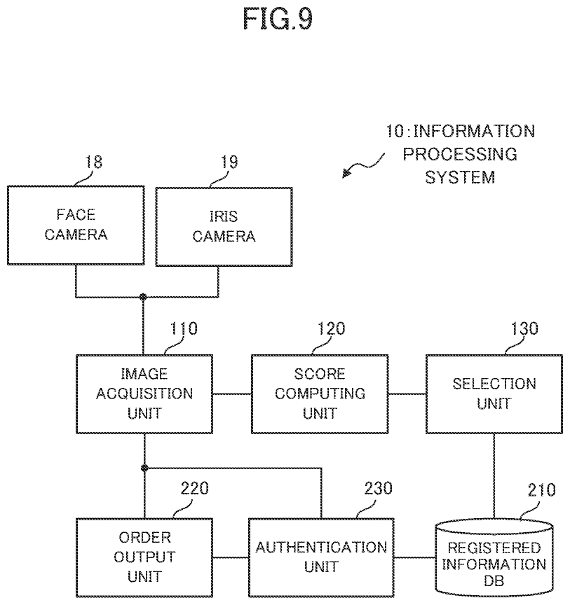

The information processing system 10 according to a third example embodiment will be described with reference to FIGS. 9 to 11. The third example embodiment differs from the above-described first and second example embodiments in a part of the configuration and operation, and the other parts may be the same as those of the first and second example embodiments. Therefore, the part that differs from the example embodiments described above will be described in detail below, and the other overlapping parts will not be described as appropriate.

### (Functional Configuration)

First, referring to FIG. 9, a description will be given of a functional configuration of the information processing system 10 according to the third example embodiment. FIG. 9 is a block diagram showing the functional configuration of the information processing system according to the third example embodiment. In FIG. 9, the reference signs same as in FIG. 3 are given to the components similar to in FIG. 3 respectively.

As shown in FIG. 9, the information processing system 10 according to the third example embodiment is configured to comprise the face camera 18, the iris camera 19, the image acquisition unit 110, the score computing unit 120, the selection unit 130, a registered information database (DB) 210, an order output unit 220, and an authentication unit 230 as components for realizing the functions thereof. That is, the information processing system 10 according to the third example embodiment further comprises, in addition to the configuration of the first example embodiment (see FIG. 3), the registered information database 210, the order output unit 220, and the authentication unit 230. The registered information database 210 may be realized by, for example, the storage apparatus 14 described above. Further, each of the order output unit 220, and the authentication unit 230 may be a processing block which is realized by, for example, the processor 11 described above (see FIG. 1).

The registered information database 210 is a database configured to store the registered images to be used in authentication. The registered information database 210 stores the face image and the iris image each having been selected by the selection unit 130. Alternatively, the registered information database 210 may store feature amount extracted from the face image and the iris image each having been selected by the selection unit 130. The registered information database 210 may be configured so as to store the face image and the iris image in association with each other. However, the registered information database 210 may be configured so as to store only either one of the face image and the iris image. The expiration date may be set to the information stored in the registered information database 210. For example, information about a temporary guest may be automatically deleted after a predetermined period of time has elapsed (e.g. one week later) from registration. The information stored in the registered information database 210 may be configured to so as to allow a user having a predetermined authority (for example, a system administrator, a registered user, or the like) to confirm the information therein. The face image and the iris image each stored in the registered information database 210 are appropriately readable by the authentication unit 230 described later.

The order output unit 220 is configured so as to output information relating to the order for authentication (hereinafter, appropriately referred to as the “order information”) when at least one of the face image and the iris image which have been acquired at the moment of authentication includes a plurality of authentication target. More specifically, the order output unit 220 is configured to output the order information so as to be displayed in a superimposed manner on a screen where the plurality of authentication targets are captured. The order for authentication may be determined, for example, based on the size of authentication target in the image. For example, the order of the authentication target who has been captured most largely in the image may be determined to be an early order, and the order of the authentication target who has been captured most small in the image may be determined to be a late order. Alternatively, the interocular distance or an image of depth camera may be used to perform authentication in order of the closest to the camera. However, the order for authentication may be determined randomly. The order information may be outputted to the plurality of authentication targets. For example, the order information may be shown as an image on a display or the like. The order information may be audio-outputted using a speaker or the like. Specific output examples of the order information will be described in detail later.

The authentication unit 230 is configured so as to perform authentication processing (i.e. the facial authentication and the iris authentication) by comparing the face image and iris image of the authentication target acquired at the moment of the authentication to the face image and iris image of the registered target registered in the registered information database 210. The authentication unit 230 may be configured to execute the authentication processing using the face feature amount extracted from the face image and the iris feature amount extracted from the iris image. The authentication unit 230 may execute the facial authentication and the iris authentication separately and output an authentication result obtained by integrating the results thereof. For example, the authentication unit 230 may output the authentication result which is successful, when both the facial authentication and the iris authentication are successful; and may output the authentication result which is failed, when at least one of the facial authentication and the iris authentication is failed. Alternatively, the authentication unit 230 may output the authentication result which is successful, when at least one of the facial authentication and the iris authentication is successful; and may output the authentication result which is failed, when both the facial authentication and the iris authentication are failed.

Further, the authentication unit 230 according to the third example embodiment, in particular, performs the authentication according to the order information outputted by the order output unit 220. For example, in a case that there is outputted from the order output unit 220, the order information indicating that the order of target A is “1” and the order of target B is “2”, the authentication unit 230 first performs the authentication processing on the target A and then performs the authentication processing on the target B. Here, the order indicates what number target is authenticated. For example, “1” indicates that the target is authenticated first, and “2” indicates that the target is authenticated second.

### (Authentication Operation)

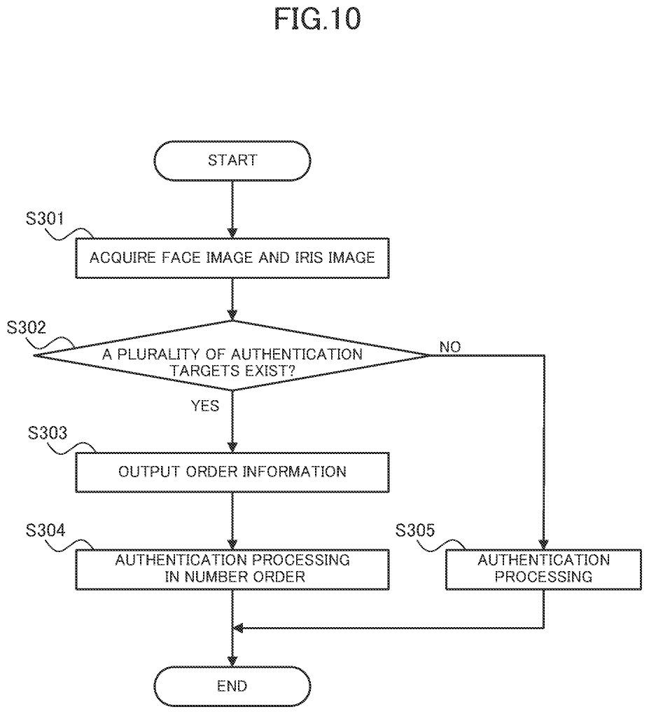

Next, referring to FIG. 10, a flow of operation for performing the authentication using the face image and the iris image (hereinafter, referred to as the “authentication operation” as appropriate) will be described, the operation being performed by the information processing system 10 according to the third example embodiment. FIG. 10 is a flow chart showing the flow of authentication operation by the information processing system according to the third example embodiment.

As shown in FIG. 10, when the authentication operation by the information processing system according to the third example embodiment is started, first, the image acquisition unit 110 acquires the face image and iris image of the authentication target (step S301). Thereafter, the order output unit 220 determines whether or not a plurality of authentication targets exist (i.e. whether or not they are captured) in at least one of the face image and the iris image, which have been acquired by the image acquisition unit 110 (step S302).

In a case that the plurality of authentication targets exist (step S302: YES), the order output unit 220 determines the order for authentication with respect to each of the plurality of authentication targets and outputs the order information (step S304). In this case, the authentication unit 230 executes the authentication processing in the order corresponding to the order information (step S305).

On the other hand, in a case that the plurality of authentication targets do not exist (step S302: NO), the order output unit 220 does not output the order information (i.e. the process of the step S303 is omitted). In this case, the authentication unit 230 executes the authentication processing normally on the authentication target captured in the image (step S305).

### (Display Examples of Order)

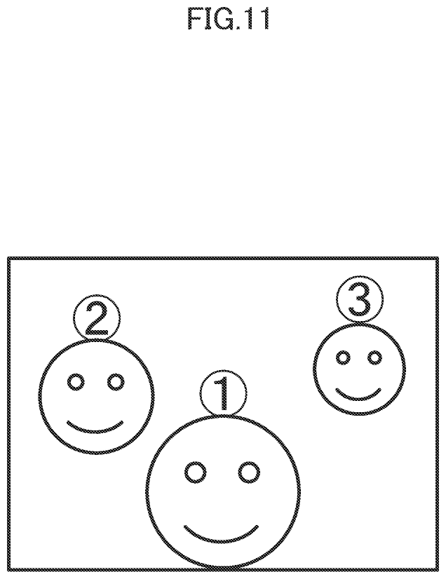

Next, referring to FIG. 11, display examples of the order in the information processing system according to the third example embodiment (i.e. output examples of the information relating to the order by the order output unit 220) will be described. FIG. 11 is a plan view showing an example of order display by the information processing system according to the third example embodiment.

As shown in FIG. 11, the order information may be outputted, for example, as information which is displayed so that the number indicating the order for authentication is shown in a superposed manner on the image. In this case, the number indicating the order for authenticate may be displayed on each face of the plurality of authentication targets. Alternatively, the order information may be outputted as information for displaying in a blurred manner, the faces of authentication targets except the authentication target whose order for authentication is coming. For example, in a case that the order of target A is “1”, the order of target B is “2”, and the order of target C is “3”; the face of the target A is displayed normally first, and the faces of the other targets are displayed in a blurred manner. After that, when target A's authentication processing is finished, the face of the target B is displayed normally, and the faces of the other targets are displayed in a blurred manner. After that, when target B's authentication processing is finished, the face of the target C is displayed normally, and the faces of the other targets are displayed in a blurred manner. When the target whose order is coming is not shown in the center of the screen (i.e. at an appropriate authentication position), but is shown, for example, at the edge of the screen, information for guiding the target to the appropriate position may be outputted in addition to the information indicating the order described above. For example, at the moment when the authentication on the target A is completed and then the authentication on the target B is starting, if the target B exists at the edge of the screen, a message such as “MOVE TO LEFT A LITTLE” or “MOVE TO ARROW DIRECTION IN SCREEN (with display of the arrow pointing in the direction to move the target)” may be outputted to the target B while blurring the faces of targets except the target B. This message may be displayed on the screen, or may be audio-outputted by a speaker or the like.

### (Technical Effects)

Next, technical effects obtained by the information processing system 10 according to the third example embodiment will be described.

As described in FIGS. 9 to 11, in the information processing system 10 according to the third example embodiment, the order information is outputted when a plurality of authentication targets are captured. By this way, since it is possible to notify the authentication targets of the order for authentication, even if there are more than one authentication target, the authentication processing can be performed appropriately. For example, by guiding each of the authentication targets to the appropriate position at appropriate timing, the authentication processing can be performed with high accuracy.

### Fourth Example Embodiment

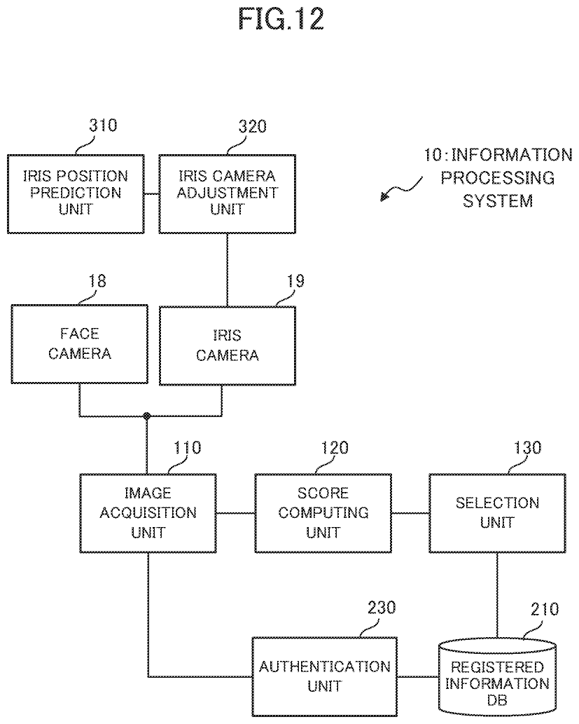

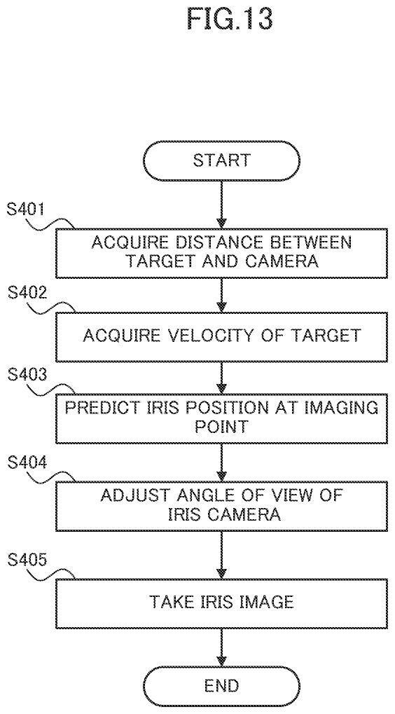

The information processing system 10 according to a fourth example embodiment will be described with reference to FIGS. 12 and 13. The fourth example embodiment differs from the above-described first to third example embodiments only in a part of configuration and operations, and the other parts may be the same as those in the first to third example embodiments. Therefore, the part that differs from the first example embodiment described above will be described in detail below, and the other overlapping parts will not be described as appropriate.

### (Functional Configuration)

First, referring to FIG. 12, a description will be given of a functional configuration of the information processing system 10 according to the fourth example embodiment. FIG. 12 is a block diagram showing the functional configuration of the information processing system according to the fourth example embodiment. In FIG. 12, the reference signs same as in FIG. 9 are given to the components similar to in FIG. 9 respectively.

As shown in FIG. 12, the information processing system 10 according to the fourth example embodiment is configured to comprise the face camera 18, the iris camera 19, the image acquisition unit 110, the score computing unit 120, the selection unit 130, the registered information database (DB) 210, the authentication unit 230, an iris position prediction unit 310, and an iris camera adjustment unit 320 as components for realizing the functions thereof. That is, the information processing system 10 according to the fourth example embodiment further comprises, in addition to the configuration of the first example embodiment (see FIG. 3), the registered information database 210, the authentication unit 230, the iris position prediction unit 310, and the iris camera adjustment unit 320. The registered information database 210 and the authentication unit 230 may be the same as those in the third example embodiment. Each of the iris position prediction unit 310 and the iris camera adjustment unit 320 may be a processing block which is realized by, for example, the processor 11 described above (see FIG. 1).

The iris position prediction unit 310 is configured to predict the position of the iris of the authentication target at the moment of taking the iris image, based on the distance from the authentication target to the iris camera 19 and velocity of the authentication target. Alternatively, the iris position prediction unit 310 may be configured to predict the position of the iris of the authentication target at the moment of taking the iris image, based on the present position of the authentication target. For example, the iris position prediction unit 310 may be configured so as to predict how high the iris of the authentication target would be at the focal position of the iris camera 19. The distance from the authentication target to the iris camera 19 and the velocity of the authentication target may be acquired using various sensors or may be acquired from an image of the authentication target. The iris position prediction unit 310 is configured to output the position of the iris predicted thereby to the iris camera adjustment unit 320.

The iris camera adjustment unit 320 is configured to adjust an angle of view of the iris camera 19 based on the position of the iris predicted by the iris position prediction unit 310. The angle of view of the iris camera 19 may be adjusted, for example, by changing, with respect to the iris camera, the height, the lateral position, the angle, and the like. For example, the iris camera adjustment unit 320 may adjust the height of the iris camera 19 so that the iris of the target is included in the iris image to be taken at the focal position. In this case, the iris camera adjustment unit 320 may adjust the height by moving the iris camera 19 itself, for example. Alternatively, the iris camera adjustment unit 320 may adjust the height by selecting one iris camera 19 to be used for the imaging from a plurality of iris cameras 19 each having different height from each other. Similarly, the iris camera adjustment unit 320 may adjust the lateral position of the iris camera 19 so that the iris of the target is included in the iris image to be taken at the focal position. In this case, the iris camera adjustment unit 320 may adjust the lateral position by moving the iris camera 19 itself, for example. Alternatively, the iris camera adjustment unit 320 may adjust the lateral position by selecting one iris camera 19 to be used for the imaging from a plurality of iris cameras 19 each having different lateral position from each other. Similarly, the iris camera adjustment unit 320 may adjust the angle of the iris camera 19 so that the iris of the target is included in the iris image to be taken at the focal position. In this case, the iris camera adjustment unit 320 may adjust the angle by moving the iris camera 19 itself, for example. Alternatively, the iris camera adjustment unit 320 may adjust the angle by selecting one iris camera 19 to be used for the imaging from a plurality of iris cameras 19 each having different angle from each other. The iris camera adjustment unit 320 may change any one parameter of the height, lateral position, and angle with respect to the iris camera 19, or may change more than one parameter.

### (Iris Imaging Operation)

Next, referring to FIG. 13, a flow of operation performed when taking the iris image (hereinafter, referred to as the “iris imaging operation”) by the information processing system 10 according to the fourth example embodiment will be described. FIG. 13 is a flowchart showing the flow of the iris imaging operation by the information processing system according to the fourth example embodiment.

As shown in FIG. 13, when the iris imaging operation by the information processing system according to the fourth example embodiment is started, first, the iris position prediction unit 310 acquires the distance between the target and the iris camera 19 (step S401). Then, the iris position prediction unit 310 acquires the velocity of the target (step S402). Processes of the steps S401 and S402 may be executed simultaneously in parallel, or may be executed in tandem.

Subsequently, the iris position prediction unit 310 predicts the iris position at the imaging point based on the acquired distance between the target and the iris camera 19 and the acquired velocity of the target (step S403). Then, the iris camera adjustment unit 320 adjusts the angle of view of the iris camera 19 based on the iris position predicted by the iris position prediction unit 310 (step S404). After that, the iris image of the target is taken by the iris camera 19 (step S405).

### (Technical Effects)

Next, a description will be given of technical effects obtained by the information processing system 10 according to the fourth example embodiment.

As described in FIGS. 12 and 13, in the information processing system 10 according to the fourth example embodiment, the angle of view of the iris camera 19 is adjusted based on the predicted iris position. Thus, it is possible to acquire the iris image more appropriately. For example, since the angle of view of the iris camera 19 can be adjusted before the target reaches the imaging point, the time required for authentication and the time required for acquiring the iris image can be reduced.

### Fifth Example Embodiment

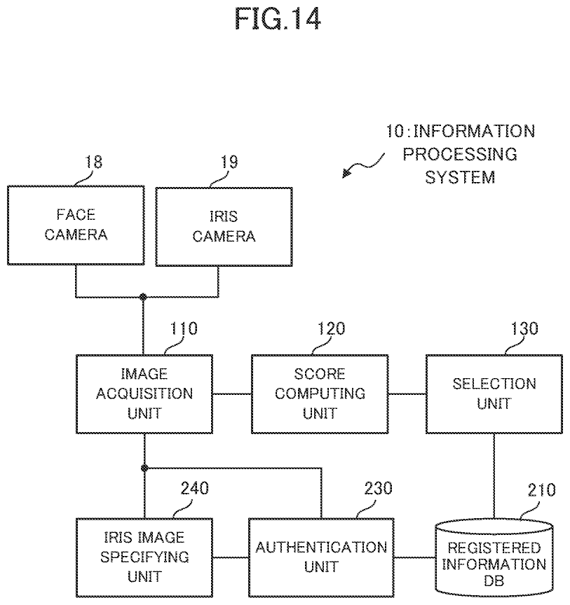

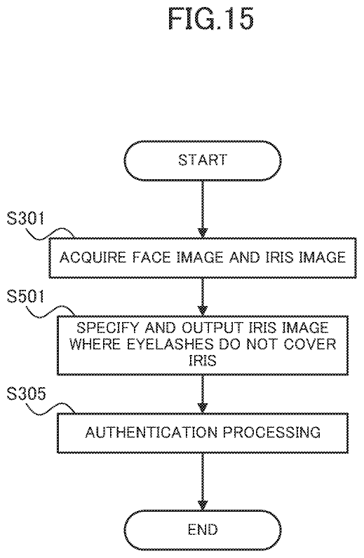

The information processing system 10 according to a fifth example embodiment will be described with reference to FIGS. 14 and 15. The fifth example embodiment differs from the above-described first to fourth example embodiments only in a part of configuration and operations, and the other parts may be the same as those in the first to fourth example embodiments. Therefore, the part that differs from the first example embodiment described above will be described in detail below, and the other overlapping parts will not be described as appropriate.

### (Functional Configuration)

First, a functional configuration of the information processing system 10 according to the fifth example embodiment will be described with reference to FIG. 14. FIG. 14 is a block diagram showing the functional configuration of the information processing system according to a fifth example embodiment. In FIG. 14, the reference signs same as in FIG. 9 are given to the components similar to in FIG. 9 respectively.

As shown in FIG. 14, the information processing system 10 according to the fifth example embodiment is configured to comprise the face camera 18, the iris camera 19, the image acquisition unit 110, the score computing unit 120, the selection unit 130, the registered information database (DB) 210, the authentication unit 230, and an iris image specifying unit 240 as components for realizing the functions thereof. That is, the information processing system according to the fifth example embodiment further comprises, in addition to the configuration of the first example embodiment (see FIG. 3), the registered information database 210, the authentication unit 230, and the iris image specifying unit 240. The registered information database 210 and the authentication unit 230 may be the same as those in each of the above-described example embodiments. The iris image specifying unit 240 may be a processing block which is realized by, for example, the processor 11 described above (see FIG. 1).

The iris image specifying unit 240 is configured to specify out of a plurality of iris images, an iris image where no eyelashes cover the iris. As a method of determining that the eyelashes do not cover the iris, any existing technology can be adopted as appropriate. Further, the iris image specifying unit 240 outputs an image where the eyelashes do not cover the iris, as the iris image to be used for authentication. In other words, the iris image specifying unit 240 does not output an image where the eyelashes cover the iris as the iris image to be used for authentication. In a case that there is more than one image where the eyelashes do not cover the iris, the iris image specifying unit 240 may select and output one of the images. For example, the iris image specifying unit 240 may select and output the highest-quality image from the images where the eyelashes do not cover the iris. Also, if there is no image where the eyelashes are not hanging on the iris (i.e. the eyelashes are hanging on the iris in all image), then the iris image specifying unit 240 may further output an instruction to image acquisition unit 110 to acquire image.

### (Authentication Operation)

Next, referring to FIG. 15, a flow of authentication operation by the information processing system 10 according to the fifth example embodiment will be described. FIG. 15 is a flow chart showing the flow of the authentication operation by the information processing system according to the fifth example embodiment. In FIG. 15, the reference signs same as in FIG. 10 are given to the processes similar to in FIG. 10 respectively.

As shown in FIG. 15, when the authentication operation by the information processing system according to the fifth example embodiment is started, first, the image acquisition unit 110 acquires the face image and iris image of the authentication target (step S301). In the fifth example embodiment, in particular, a plurality of images are acquired with respect to at least the iris image.

Subsequently, the iris image specifying unit 240 specifies an image where the eyelashes do not cover the iris from the plurality of iris images, and outputs it as the image to be used for authentication (step S501). Then, the authentication unit 230 executes the authentication processing using the iris image outputted from the iris image specifying unit 240 (step S303).

### (Technical Effects)

Next, technical effects obtained by the information processing system 10 according to the fifth example embodiment will be described.

As described in FIGS. 14 and 15, in the information processing system 10 according to the fifth example embodiment, among the plurality of iris images, the iris image where the eyelashes do not cover the iris is specified and used for authentication. By this way, it is possible to suppress a decrease in authentication accuracy caused by the eyelashes.

### Sixth Example Embodiment

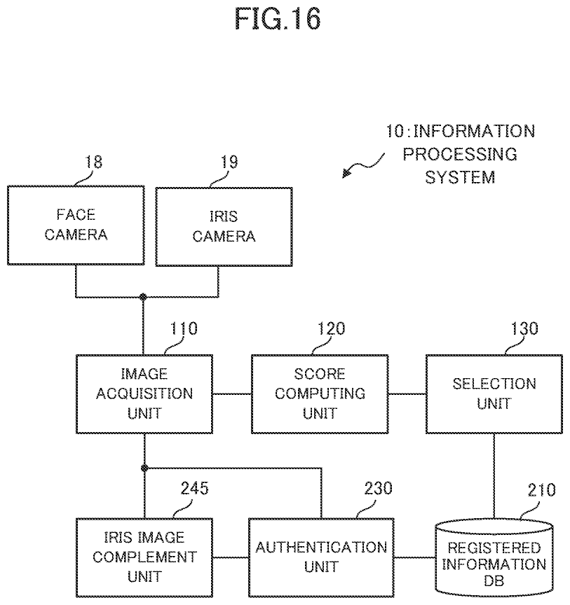

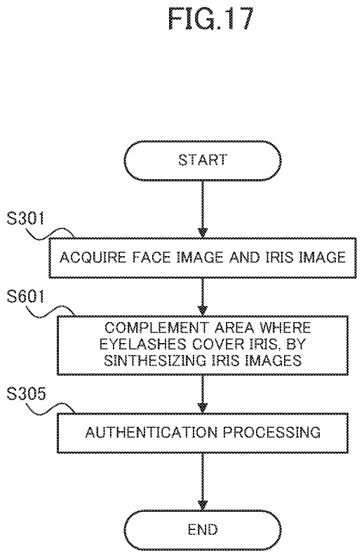

The information processing system 10 according to the sixth example embodiment will be described with reference to FIGS. 16 and 17. The sixth example embodiment differs from the above-described fifth example embodiment only in a part of configuration and operations, and the other parts may be the same as those in the first to fifth example embodiments. Therefore, the part that differs from the first example embodiment described above will be described in detail below, and the other overlapping parts will not be described as appropriate.

### (Functional Configuration)

First, a functional configuration of the information processing system 10 according to the sixth example embodiment will be described with reference to FIG. 16. FIG. 16 is a block diagram showing the functional configuration of the information processing system according to the sixth example embodiment. In FIG. 16, the reference signs same as in FIG. 14 are given to the components similar to in FIG. 14 respectively.

As shown in FIG. 16, the information processing system 10 according to the sixth example embodiment is configured to comprise the face camera 18, the iris camera 19, the image acquisition unit 110, the score computing unit 120, the selection unit 130, the registered information database (DB) 210, the authentication unit 230, and an iris image complement unit 245 as components for realizing the functions thereof. That is, the information processing system according to the sixth example embodiment comprises the iris image complement unit 245 instead of the iris image specifying unit 240 in the fifth example embodiment (see FIG. 14). The iris image complement unit 245 may be a processing block which is realized by, for example, the processor 11 described above (see FIG. 1).

The iris image complement unit 245 is configured so as to complement an area covered by the eyelashes by synthesizing a plurality of iris images where the eyelashes cover the iris. For example, in a case that there is the plurality of iris images where the eyelashes cover the iris, the area covered by the eyelashes (i.e. the iris area that becomes invisible because of the eyelashes) differs for each image. Thus, if the plurality of iris images are synthesized, it is possible to mutually complement the area covered by the eyelashes in each image. When synthesizing the plurality of iris images, there may be performed processing of, for example, masking the eyelashes and summing the images. The iris image complement unit 245 may output the iris image complemented by the synthesis as the iris image to be used for authentication. If there is an image where the eyelashes do not cover the iris, the iris image complement unit 245 may omit the processing of synthesizing the iris images. In addition, in a case that the area where the eyelashes cover the iris cannot be complemented even if the plurality of images are synthesized. (i.e. in a case that information for the complement is insufficient), the iris image complement unit 245 may output an instruction to the image acquisition unit 110 so as to further acquire the image.

### (Authentication Operation)

Next, referring to FIG. 17, a flow of authentication operation by the information processing system 10 according to the sixth example embodiment will be described. FIG. 17 is a flow chart illustrating a flow of the authentication operation by the information processing system according to the sixth example embodiment. In FIG. 17, the reference signs same as in FIG. 15 are given to the processes similar to in FIG. 15 respectively.

As shown in FIG. 17, when the authentication operation by the information processing system according to the sixth example embodiment is started, first, the image acquisition unit 110 acquires the face image and iris image of the authentication target (step S301). In the fifth example embodiment, in particular, a plurality of images are acquired with respect to at least the iris image.

The iris image complement unit 245 then complement the area where the eyelashes cover the iris by synthesizing the plurality of iris images (step S601). Then, the authentication unit 230 executes the authentication processing using the iris image synthesized by the iris image complement unit 245 (step S303).

### (Technical Effects)

Next, a description will be given of technical effects obtained by the information processing system 10 according to the sixth example embodiment.

As described in FIGS. 16 and 17, in the information processing system 10 according to the sixth example embodiment, a plurality of iris images are synthesized, thereby complementing the area where the eyelashes cover the iris. By this way, it is possible to suppress a decrease in authentication accuracy caused by the eyelashes.

### Seventh Example Embodiment

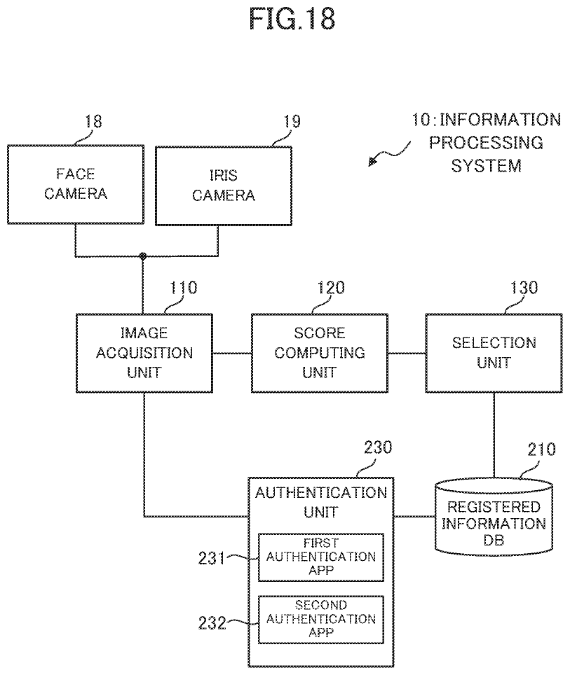

The information processing system 10 according to the seventh example embodiment will be described with reference to FIG. 18. The seventh example embodiment differs from the above-described first to sixth example embodiments only in a part of configuration and operations, and the other parts may be the same as those in the first to sixth example embodiments. Therefore, the part that differs from the first example embodiment described above will be described in detail below, and the other overlapping parts will not be described as appropriate.

### (Functional Configuration)

First, a functional configuration of the information processing system 10 according to the seventh example embodiment will be described with reference to FIG. 18. FIG. 18 is a block diagram showing the functional configuration of the information processing system according to the seventh example embodiment. In FIG. 18, the reference signs same as in FIG. 9 are given to the components similar to in FIG. 9 respectively.

As shown in FIG. 18, the information processing system 10 according to the seventh example embodiment is configured to comprise the face camera 18, the iris camera 19, the image acquisition unit 110, the score computing unit 120, the selection unit 130, the registered information database (DB) 210, the authentication unit 230 as components for realizing the functions thereof. The authentication unit 230 according to the seventh example embodiment a first authentication application 231 and a second authentication application 232.

The first authentication app 231 and the second authentication app 232 are each configured as an application capable of executing the authentication processing. The first authentication app 231 and the second authentication app 232 are configured so as to execute the authentication processing on the authentication targets different each other respectively. For example, the first authentication app 231 is configured to execute the authentication processing on the first authentication target, and the second authentication app 232 is configured to execute the authentication processing on the second authentication target. The first authentication app 231 and the second authentication app 232 each have functions required for authentication, such as processing for detecting the face and the iris, processing for extracting feature amount from the face image and the iris image, and processing for performing authentication using the extracted feature amount. In particular, the first authentication app 231 and the second authentication app 232 are configured so as to be operated in parallel with each other. For example, while the first authentication app 231 is executing the authentication processing on the target A, the second authentication 232 is allowed to execute the authentication processing on the target B. Although an example that the authentication unit 230 comprises two authentication applications is described here, the authentication unit 230 may be configured to comprise, for example, three or more authentication applications. In this case, the authentication unit 230 may be configured so that three or more applications are executed in parallel. The plurality of applications including the first authentication application 231 and the second authentication application 232 may be configured so as to operate at one terminal.

### (Technical Effects)

Next, technical effects obtained by the information processing system 10 according to the seventh example embodiment will be described.

As described in FIG. 18, in the information processing system 10 according to the seventh example embodiment, the first authentication application 231 and the second authentication application 232 can be operated in parallel. By this way, the authentication processing for more than one authentication target can be each executed concurrently; it is possible to enable the authentication to be executed more efficiently. In addition, by operating more than one application on a single terminal, it is possible to perform the authentication using the face and iris with respect to more than one target on a single terminal (i.e. without a plurality of terminals).

### Eighth Example Embodiment

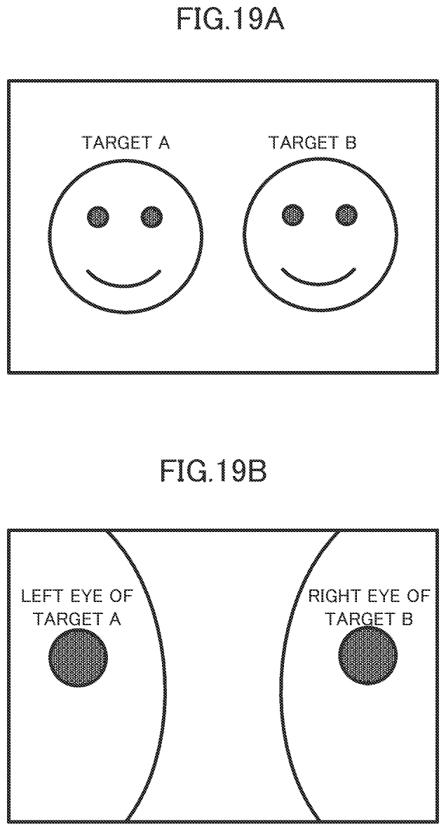

The information processing system 10 according to an eighth example embodiment will be described with reference to FIGS. 19A and 19B. The eighth example embodiment differs from the above-described seventh example embodiment only in a part of configuration and operations, and the other parts may be the same as those in the first to seventh example embodiments. Therefore, the part that differs from the first example embodiment described above will be described in detail below, and the other overlapping parts will not be described as appropriate.

### (Authentication Operation)

First, referring to FIGS. 19A and 19B, authentication operation by the information processing system 10 according to the eighth example embodiment will be described. Each of FIGS. 19A and 19B is a plan view showing a specific example of the authentication operation by the information processing system according to the eighth example embodiment.

As shown in FIGS. 19A and 19B, in the authentication operation performed by the information processing system 10 according to the eighth example embodiment, the authentication processing using the face image and iris image where a plurality of authentication targets are captured is executed. Specifically, the authentication unit 230 according to the eighth example embodiment is capable of executing the authentication processing using the face image of the authentication target and a single-eye image of the authentication target.

For example, the authentication processing on the target A is performed using: a portion including the target A in the face image shown in FIG. 19A; and a portion including the left eye of the target A in the iris image shown in FIG. 19B. This authentication processing may be executed, for example, by the first authentication app 231 (see FIG. 18). In addition, the authentication processing on the target B is performed using: a portion including the target B in the face image shown in FIG. 19A; and a portion including the right eye of the target B in the iris image shown in FIG. 19B. This authentication processing may be executed, for example, by the second authentication application 231 (see FIG. 18).

### (Technical Effects)

Next, technical effects obtained by the information processing system 10 according to the eighth example embodiment will be described.

As described in FIGS. 19A and 19B, in the information processing system 10 according to the eighth example embodiment, the authentication processing is executed using the face image and the single-eye image with respect to a plurality of authentication targets. This allows the authentication processing to be executed appropriately even when more than one authentication target is captured in a single image. In addition, by operating multiple apps on a single terminal, it is possible to perform authentication using each of the face and the iris with respect to more than one authentication target concurrently on a single terminal. (i.e. without a plurality of terminals).

### Ninth Example Embodiment

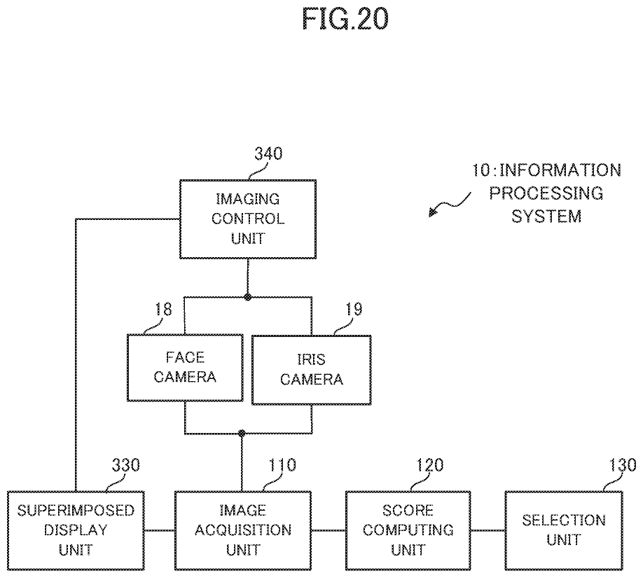

The information processing system 10 according to a ninth example embodiment will be described with reference to FIGS. 20 to 22. The ninth example embodiment differs from the above-described first to eighth example embodiments only in a part of configuration and operations, and the other parts may be the same as those in the first to eighth example embodiments. Therefore, the part that differs from the first example embodiment described above will be described in detail below, and the other overlapping parts will not be described as appropriate.

### (Functional Configuration)

First, a functional configuration of the information processing system 10 according to the ninth example embodiment will be described with reference to FIG. 20. FIG. 20 is a block diagram showing the functional configuration of the information processing system according to a ninth example embodiment. In FIG. 20, the reference signs same as in FIG. 3 are given to the components similar to in FIG. 3 respectively.

As shown in FIG. 20, the information processing system 10 according to the ninth example embodiment is configured to comprise the face camera 18, the iris camera 19, the image acquisition unit 110, the score computing unit 120, the selection unit 130, a superimposed display unit 330, and an imaging control unit 340 as components for realizing the functions thereof. That is, the information processing system 10 according to the ninth example embodiment further comprises, in addition to the configuration of the first example embodiment (see FIG. 3), the superimposed display unit 330 and the imaging control unit 340. Each of the superimposed display unit 330 and the imaging control unit 340 may be a processing block which is realized by, for example, the processor 11 described above (see FIG. 1).

The superimposed display unit 330 is configured so as to display in a superimposed manner a first mark at the eyes periphery of the registration target after taking the face image of the registration target. The first mark may be displayed as, for example, a frame surrounding the eyes periphery of the registration target. For example, when the position of the eyes in image is changed, the first mark is displayed so as to follow the eyes. Further, the superimposed display unit 330 is configured so as to display in a superimposed manner a second mark indicating the size of eyes periphery suitable for the iris image. The second mark is displayed as, for example, a mark of a shape overlapping the first mark. For example, if the first mark has a shape of a frame surrounding the eyes periphery as described above, the second mark may also have a shape of the frame. The size of the second mark may be set in advance. For example, the second mark may be suitably sized to take the iris image having pixel number sufficient to perform the iris authentication.

The imaging control unit 340 is configured to control the iris camera 19. Specifically, the imaging control unit 340 controls the iris camera 19 so that the iris image is taken when the first mark overlaps the second mark.

### (Display Examples)

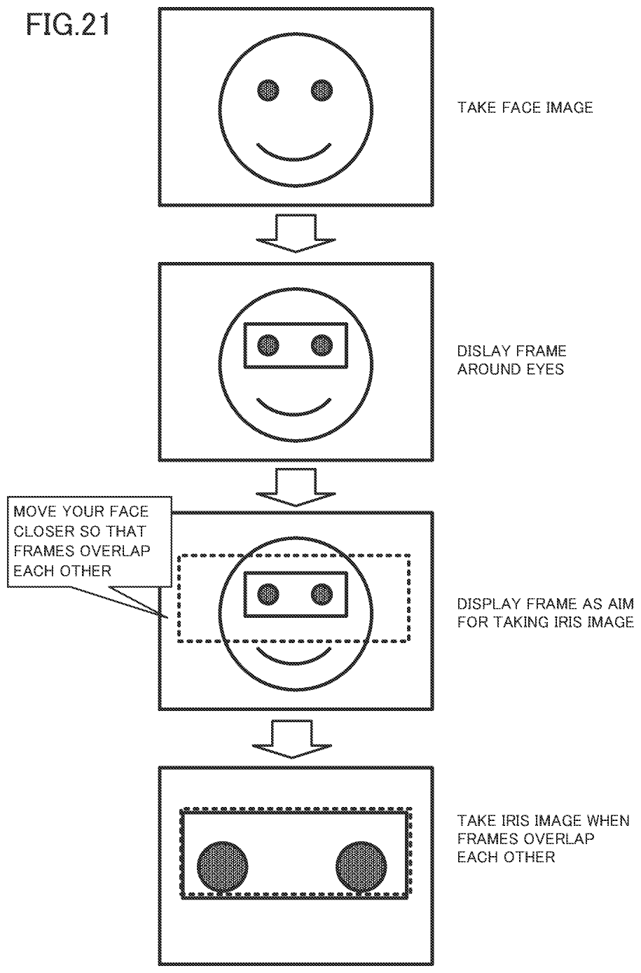

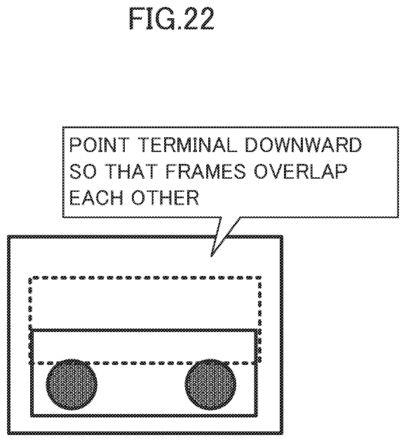

Next, display examples by the information processing system 10 according to the ninth example embodiment will be described with reference to FIGS. 21 and 22. FIG. 21 is a plan view (Part 1) showing a display example in the information processing system according to the ninth example embodiment. FIG. 22 is a plan view (Part 2) showing a display example in the information processing system according to the ninth example embodiment. In the following, an example will be described in which the face camera 18 and the iris camera 19 are configured as a single common camera (for example, a camera mounted on a smartphone).

As shown in FIG. 21, when the information processing system 10 according to the ninth example embodiment operates, first, the face image of the registration target is taken. Thereafter, the superimposed display unit 330 displays the first mark (the frame surrounding the eyes periphery) around the eyes of the registration target. Then, the superimposed display unit 330 further displays in a superimposed manner the second mark (the frame indicated by broken lines in the drawing) indicating the size of eyes periphery suitable for taking the iris image. In this case, a message “MOVE YOUR FACE CLOSER SO THAT FRAMES OVERLAP EACH OTHER” may be outputted to prompt the target to move. This message, for example, may be displayed in the image, or may be audio-outputted.

As the registration target moves his/her face closer, the face of the registration target to be imaged, is shown larger in the display area. Along with this, the first mark displayed in a superimposed manner on the eyes periphery also gets larger. On the other hand, the size of the second mark does not change. Thereafter, when the first mark overlaps the second mark (i.e. when the first mark reaches the size same as the second mark has), the iris image of the registration target is taken.

If the first mark and the second mark do not overlap each other, as shown in FIG. 22, there may be outputted to the registration target a message for successfully taking the iris image. For example, in a case that the position of the eyes is shifted downward as shown in FIG. 22, the message “POINT TERMINSL (camera) DOWNWARD SO THAT FRAMES OVERLAP EACH OTHER” may be outputted. This message, for example, may be displayed in the image, or may be audio-outputted.

### (Technical Effects)

Next, technical effects obtained by the information processing system 10 according to the ninth example embodiment will be described.

As described in FIGS. 20 to 22, in the information processing system 10 according to the ninth example embodiment, guide is given by the first mark and the second mark so that the positional relation between the registration target and the camera becomes appropriate. By this way, it is possible to take the iris image appropriately after taking the face image. For example, it is possible to image the iris having appropriate size, the iris being included in the imaging range. Further, in a case that the face image and the iris image are different from each other in the appropriate distance to the camera and the imaging range, it is possible to acquire an image having appropriate size with respect to each of the face image and the iris image.

### Tenth Example Embodiment

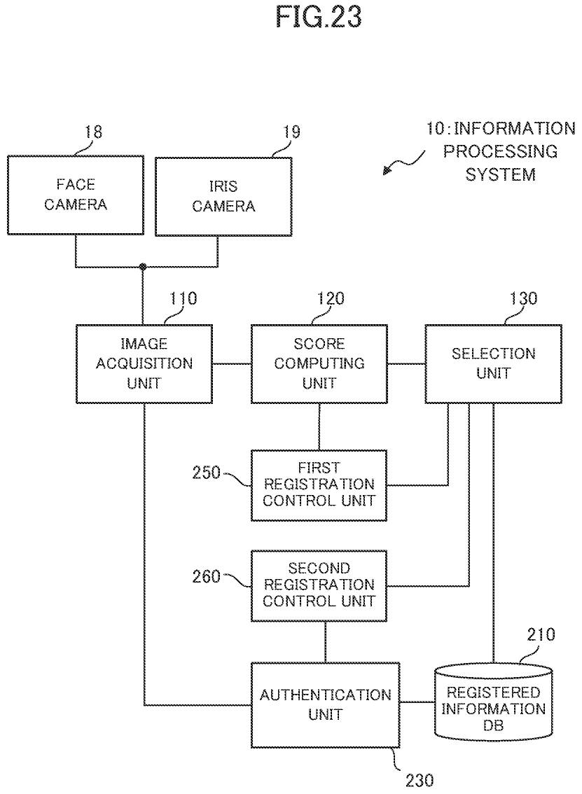

The information processing system 10 according to a tenth example embodiment will be described with reference to FIGS. 23 to 25. The tenth example embodiment differs from the above-described first to ninth example embodiments only in a part of configuration and operations, and the other parts may be the same as those in the first to ninth example embodiments. Therefore, the part that differs from the first example embodiment described above will be described in detail below, and the other overlapping parts will not be described as appropriate.

### (Functional Configuration)

First, a functional configuration of the information processing system 10 according to the tenth example embodiment will be described with reference to FIG. 23. FIG. 23 is a block diagram showing the functional configuration of the information processing system according to a tenth example embodiment. In FIG. 23, the reference signs same as in FIG. 9 are given to the components similar to in FIG. 9 respectively.

As shown in FIG. 23, the information processing system 10 according to the tenth example embodiment is configured to comprise the face camera 18, the iris camera 19, the image acquisition unit 110, the score computing unit 120, the selection unit 130, the registered information database (DB) 210, the authentication unit 230, a first registration control unit 250, and a second registration control unit 260 as components for realizing the functions thereof. That is, the information processing system 10 according to the tenth example embodiment further comprises, in addition to the configuration of the first example embodiment (see FIG. 3), the registered information database 210, the authentication unit 230, the first registration control unit 250 and the second registration control unit 260. The registered information database 210 and the authentication unit 230 may be the same as those in each of the above-described example embodiments. Each of the first registration control unit 250 and the second registration control unit 260 may be a processing block which is realized by, for example, the processor 11 described above (see FIG. 1).

The first registration control unit 250 is configured to be controllable so as to register only the face image taken by a first terminal when the quality-score of the iris image taken by the first terminal is equal to or less than a predetermined threshold (for example, when the performance of the camera mounted on the first terminal is low; an appropriate iris image cannot be taken, etc.). Further, when the iris image cannot be taken by the first terminal (for example, when a camera capable of taking the iris image is not mounted on the first terminal, for example), the first registration control unit 250 is configured so as to execute control for registering (that is, storing in the registered information database 210) only the face image taken by the first terminal. As an example of the first terminal, there is a terminal with a camera whose performance is relatively low such as a smartphone, and a terminal where a camera capable of taking the iris image is not mounted.

The second registration control unit 260 is configured so as to execute, in a case that the authentication target is not registered (that is, in a case that only the face image is registered by the first registration control unit 250) at the moment when the authentication using the face image is performed at a second terminal, control for taking and registering (that is, storing in the registered information database 210) the iris image of the authentication target through the second terminal. As an example of the second terminal, there is a terminal having a relatively high camera-performance such as a terminal dedicated for authentication.

### (Operation of First Registration Control Unit)

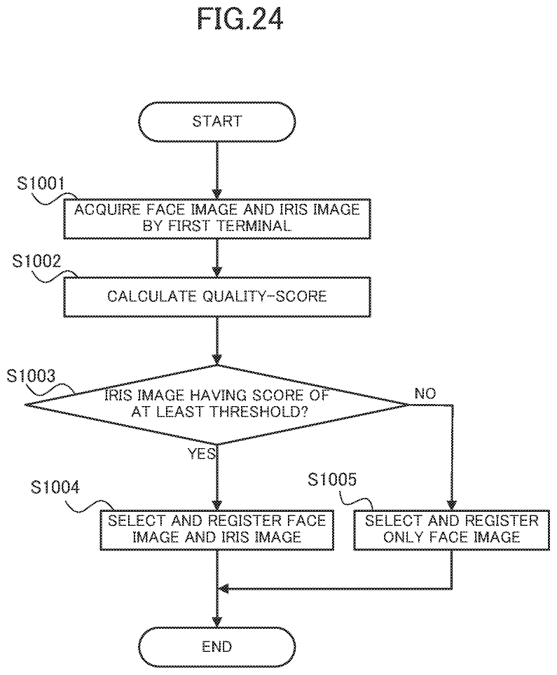

Next, with reference to FIG. 24, the operation of the first registration control unit 250 in the information processing system 10 according to the tenth example embodiment will be described. FIG. 24 is a flowchart showing a flow of the operation by the first registration control unit of the information processing system according to the tenth example embodiment.

As shown in FIG. 24, when the registration operation by the information processing system 10 according to the tenth example embodiment is started, first, the image acquisition unit 110 acquires the face image and the iris image taken by the first terminal (step S1001). If the iris image cannot be taken by the first terminal, the image acquisition unit 110 may acquire only the face image.

Subsequently, the score computing unit 120 calculates the scores with respect to the face image and iris image acquired by the image acquisition unit 110 (step S1002). Then, the first registration control unit 250 determines whether or not there is the iris image having its quality-score of at least a predetermined threshold (step S1003). In a case that it is impossible to acquire the iris image, it may be determined that there is no iris image having its quality-score of at least the predetermined threshold.

In a case that there is the iris image having its quality-score of at least the predetermined threshold (step S1003: YES), the first registration control unit 250 outputs instructions to the selection unit 130 so that the face image and iris image having the quality-score of at least the predetermined threshold are selected and registered (Step S1004). On the other hand, in a case that there is no iris image having the quality-score of at least the predetermined threshold (step S1003: NO), the first registration control unit 250 outputs instructions to the selection unit 130 so that only the face image having its quality score of at least the predetermined threshold is selected and registered (step S1005). That is, the iris image is not registered.

### (Operation of Second Registration Control Unit)

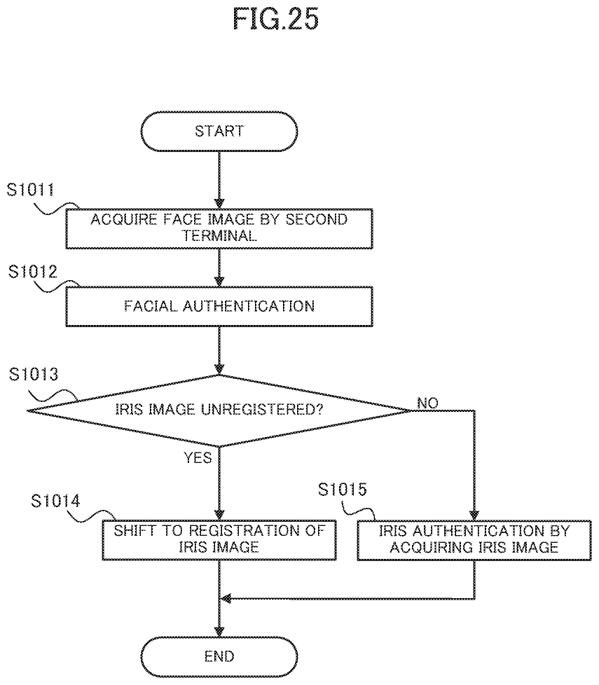

Next, with reference to FIG. 25, the operation of the second registration control unit 260 in the information processing system 10 according to the tenth example embodiment will be described. FIG. 25 is a flowchart showing a flow of the operation by the second registration control unit of the information processing system according to the tenth example embodiment.

As shown in FIG. 25, when the authentication operation by the information processing system according to the tenth example embodiment is started, first, the image acquisition unit 110 acquires the face image taken by the second terminal (step S1101). In this case, at least face image may be acquired, but the iris image may be acquired.

Subsequently, the authentication unit 230 performs the facial authentication using the face image acquired by the image acquisition unit 110 (step S1012). Here, the second registration control unit 260 determines whether or not the iris image of the authentication target who has been authenticated is unregistered (that is, whether or not stored in the registered information database 210) (step S1013).

In a case that the iris image is unregistered (step S1013: YES), the second registration control unit 260 shifts to the phase of registering the iris image of the authentication target (step S1014). That is, there is performed such processing of acquiring the iris image, calculating the quality-score thereof, and selecting based on the calculated quality-score the iris image to be registered. After registering the iris image, the iris authentication may be executed.

On the other hand, in a case that the iris image is registered (step S1013: NO), the second registration control unit 260 outputs instructions to the authentication unit 230 to acquire the iris image and execute the iris authentication (step S1015). If the iris image is also acquired when the face image is acquired, there may be given instructions to execute the iris authentication using the iris image acquired at that time.

### (Technical Effects)

Next, technical effects obtained by the information processing system 10 according to the tenth example embodiment will be described.

As described in FIGS. 23 to 25, in the information processing system 10 according to the tenth example embodiment, only the face image is registered at the first terminal, and the iris image is registered at the second terminal. By this way, even if both the face image and the iris image cannot be registered on one terminal, the iris image could be registered when authentication is performed on the other terminal. Further, since the iris image is registered after authentication using the face image already registered, the identity of the target is also guaranteed.

### Eleventh Example Embodiment

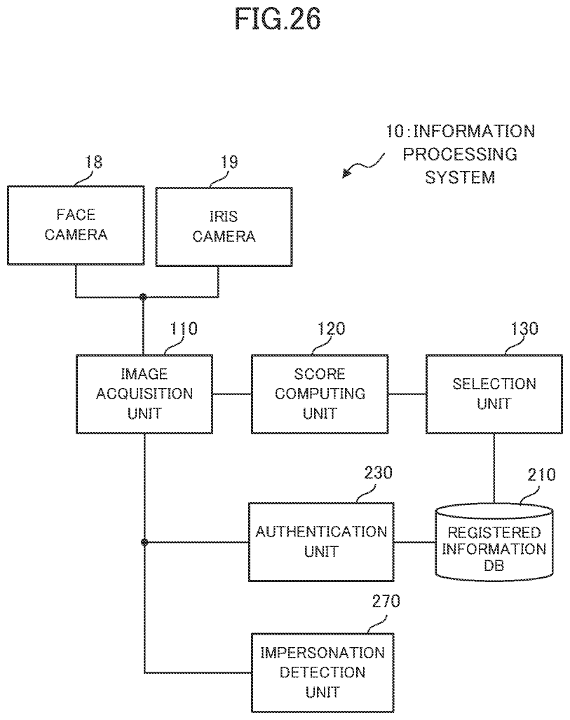

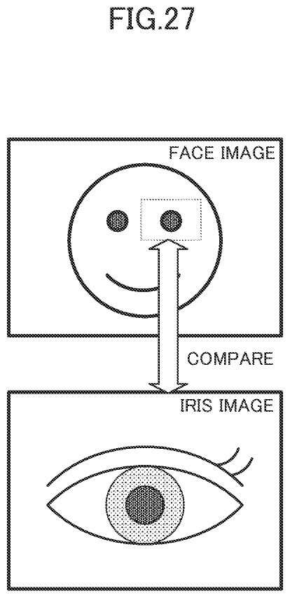

The information processing system 10 according to a eleventh example embodiment will be described with reference to FIGS. 26 and 27. The eleventh example embodiment differs from the above-described first to tenth example embodiments only in a part of configuration and operations, and the other parts may be the same as those in the first to tenth example embodiments. Therefore, the part that differs from the first example embodiment described above will be described in detail below, and the other overlapping parts will not be described as appropriate.

### (Functional Configuration)

First, a functional configuration of the information processing system 10 according to the eleventh example embodiment will be described with reference to FIG. 26. FIG. 26 is a block diagram showing the functional configuration of the information processing system according to the eleventh example embodiment. In FIG. 26, the reference signs same as in FIG. 9 are given to the components similar to in FIG. 9 respectively.

As shown in FIG. 26, the information processing system 10 according to the eleventh example embodiment is configured to comprise the face camera 18, the iris camera 19, the image acquisition unit 110, the score computing unit 120, the selection unit 130, the registered information database (DB) 210, the authentication unit 230, an impersonation detection unit 270 as components for realizing the functions thereof. That is, the information processing system 10 according to the eleventh example embodiment further comprises, in addition to the configuration of the first example embodiment (see FIG. 3), the registered information database 210, the authentication unit 230, and the impersonation detection unit 270. The registered information database 210 and the authentication unit 230 may be the same as those in each of the above-described example embodiments. The impersonation detection unit 270 may be a processing block which is realized by, for example, the processor 11 described above (see FIG. 1).

The impersonation detection unit 270 is configured so as to detect impersonation of the target (e.g. impersonation using image, video, a mask, and the like). The impersonation detection unit 270 may execute the impersonation detection, for example, at the moment of registration operation. In other words, the impersonation detection may be executed by using the face image and the iris image of the registration target. In addition, the impersonation detection unit 270 may execute the impersonation detection in the authentication operation. In other words, the impersonation detection may be executed by using the face image and the iris image of the authentication target. More specific operation of the impersonation detection unit 270 will be described in detail below.

### (Impersonation Detection Operation)

Next, referring to FIG. 27, there will be specifically described operation for detecting the impersonation (hereinafter, referred to as the “impersonation detection operation”) by the information processing system 10 (specifically, the impersonation detection unit 270) according to the eleventh example embodiment. FIG. 27 is a plan view showing an example of the impersonation detection operation by the information processing system according to the eleventh example embodiment.

As shown in FIG. 27, the impersonation detection unit 270 compares an iris area (i.e. an area where the iris is captured) included in the face image to the iris image, and detects the impersonation when at least predetermined difference between them is detected. Here, “at least predetermined difference” may be determined in advance as a threshold value for detecting the impersonation. For example, in addition to the difference in the feature amount of the iris, the difference in color or pattern with respect to the iris may be included. The difference between the iris area and the iris image may be detected by using, for example, eyes color, eyelash length, wrinkles around eyes, etc. In this case, there is a possibility that the target whose face image has been taken is different from the target whose iris image has been taken (i.e. one of them is doing impersonation). For example, there could be considered such a situation that when the face image is taken, the impersonation is done by wearing a mask (e.g. a 3D mask representing facial features of another person), and after that, the iris image is taken in a state that the mask has been removed. The impersonation detection unit 270 may stop the registration operation and/or the authentication operation when detecting the impersonation. Alternatively, the impersonation detection unit 270 may output an alert when detecting the impersonation.

### (Technical Effects)

Next, technical effects obtained by the information processing system 10 according to the eleventh example embodiment will be described.

As described in FIGS. 26 and 27, according to the information processing system 10 according to the eleventh example embodiment, it is possible to detect appropriately the impersonation by using the face image (specifically, the iris area included in face image) and the iris image.

### Twelfth Example Embodiment

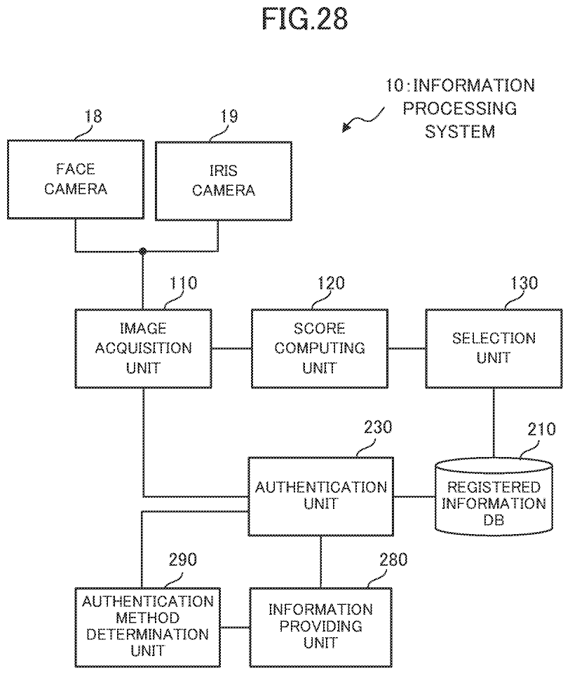

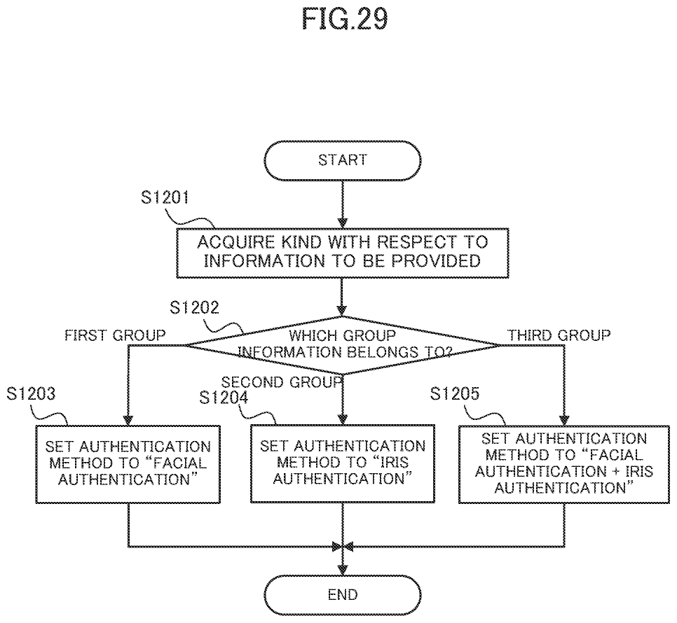

The information processing system 10 according to a twelfth example embodiment will be described with reference to FIGS. 28 and 29. The twelfth example embodiment differs from the above-described first to eleventh example embodiments only in a part of configuration and operations, and the other parts may be the same as those in the first to eleventh example embodiments. Therefore, the part that differs from the first example embodiment described above will be described in detail below, and the other overlapping parts will not be described as appropriate.

### (Functional Configuration)

First, a functional configuration of the information processing system 10 according to the twelfth example embodiment will be described with reference to FIG. 28. FIG. 28 is a block diagram showing the functional configuration of the information processing system according to the twelfth example embodiment. In FIG. 28, the reference signs same as in FIG. 9 are given to the components similar to in FIG. 9 respectively.

As shown in FIG. 28, the information processing system 10 according to the twelfth example embodiment is configured to comprise the face camera 18, the iris camera 19, the image acquisition unit 110, the score computing unit 120, the selection unit 130, the registered information database (DB) 210, the authentication unit 230, an information providing unit 280, and an authentication method determination unit 290 as components for realizing the functions thereof. That is, the information processing system 10 according to the twelfth example embodiment further comprises, in addition to the configuration of the first example embodiment (see FIG. 3), the registered information database 210, the authentication unit 230, the information providing unit 280 and the authentication method determination unit 260. The registered information database 210 and the authentication unit 230 may be the same as those in each of the above-described example embodiments. Each of the information providing unit 280 and the authentication method determination unit 290 may be a processing block which is realized by, for example, the processor 11 described above (see FIG. 1).

The information providing unit 280 is configured so as to provide (that is, output to the outside of the system) information on the authentication target based on the authentication result of the authentication unit 230. The information on the authentication target may include information such as, for example, name, address, telephone number, age, occupation, position, account number, and the like. The information on the authentication target may also include passport information, as described in other example embodiments described later. The passport information may include multiple kinds of information. For each of the various kinds of information (e.g. name, address, age, etc.) included in the passport information, a plurality of layers corresponding to, for example, the degree of importance or confidential level may be set. In addition, the information on the authentication target may include a ticket number, information on vaccination shot, information indicating whether or not having the PCR test, and the like. These kinds of information may be stored collectively in, for example, a terminal (e.g. a smartphone) owned by the target. The information providing unit 280 may be configured to provide more than one kind of information. The information provided by the information providing unit 280 may be set in advance or may be set by the authentication target, a user to whom the information is provided, and/or the like.

The authentication method determination unit 290 is configured so as to determine an authentication method in the authentication unit 230 based on the kind with respect to information to be provided by the information providing unit 280. Specifically, the authentication method determination unit 290 is configured so as to determine the type of authentication to be performed within the authentication using only the face image (the facial authentication), the authentication using only the iris image (the iris authentication), and the authentication using both the face image and the iris image (the facial authentication+the iris authentication). It may be set in advance for each kind with respect to information, which image is used for performing the authentication. For example, there may be set in advance, a first group that only the face image is used for authentication, a second group that only the iris image is used for authentication, and a third group that both the face image and the iris image are used for authentication. With respect to the information to which the plurality of layers are set such as the above mentioned passport information, the group may be set for each layer. For example, the “name”, the “age”, and the “address” included in the passport information may be divided into the groups different from each other, such as the first group, the second group, and the third group respectively.

### (Authentication Method Determination Operation)

Next, referring to FIG. 29, the operation for determining authentication method (hereinafter, referred to as “authentication method determination operation”) by the information processing system 10 (specifically, the authentication method determination unit 290) according to the twelfth example embodiment will be specifically described. FIG. 29 is a flowchart showing an example of authentication method-determination operation by the information processing system according to the twelfth example embodiment.

As shown in FIG. 29, when the authentication method determination operation by the information processing system 10 according to the twelfth example embodiment is started, first, the authentication method determination unit 290 acquires the kind with respect to information to be provided (step S1201). Then, the authentication method determination unit 290 determines the group to which the kind of the information to be provided belongs (step S1202).

In a case that the kind with respect to information to be provided is included in the first group, the authentication method determination unit 290 sets the authentication method to “the facial authentication” (step S1203). In this case, if the facial authentication is successful (regardless of the result of the iris authentication), then the information on the authentication target is provided by the information providing unit 280. In a case that the kind with respect to information to be provided is included in the second group, the authentication method determination unit 290 sets the authentication method to “the iris authentication” (step S1204). In this case, if the iris authentication is successful (regardless of the result of the facial authentication), then the information on the authentication target is provided by the information providing unit 280. In a case that the type of information to be provided is included in the third group, the authentication method determination unit 290 sets the authentication method to “the facial authentication+the iris authentication” (step S1205). In this case, if both the facial authentication and the iris authentication are successful, the information on the authentication target is provided by the information providing unit 280.

### (Technical Effects)

Next, technical effects obtained by the information processing system 10 according to the twelfth example embodiment will be described.

As described in FIGS. 28 and 29, in the information processing system 10 according to the twelfth example embodiment, the authentication method is determined based on the kind with respect to information to be provided. By this way, it is possible to perform appropriate authentication processing according to the quality and contents of information to provide the information

### Thirteenth Example Embodiment

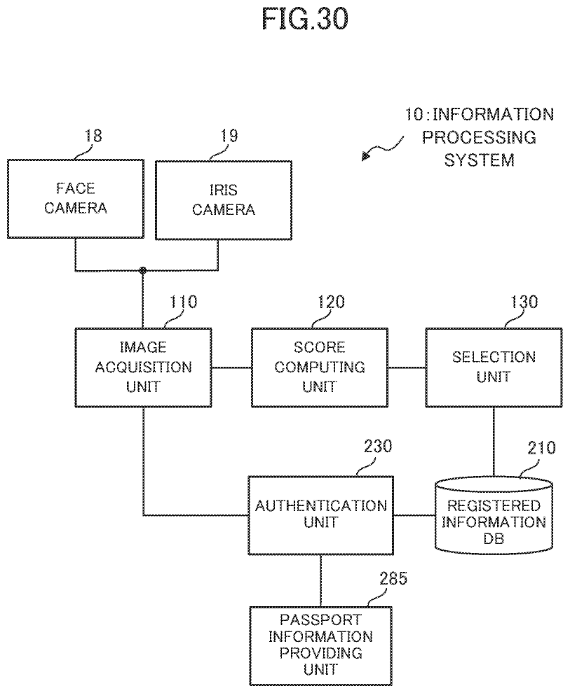

The information processing system 10 according to a thirteenth example embodiment will be described with reference to FIG. 30. The thirteenth example embodiment differs from the above-described twelfth example embodiments only in a part of configuration and operations, and the other parts may be the same as those in the first to twelfth example embodiments. Therefore, the part that differs from the first example embodiment described above will be described in detail below, and the other overlapping parts will not be described as appropriate.

### (Functional Configuration)

First, a functional configuration of the information processing system 10 according to the thirteenth example embodiment will be described with reference to FIG. 30. FIG. 30 is a block diagram showing the functional configuration of the information processing system according to the thirteenth example embodiment. In FIG. 30, the reference signs same as in FIG. 28 are given to the components similar to in FIG. 28 respectively.

As shown in FIG. 30, the information processing system 10 according to the thirteenth example embodiment is configured to comprise the face camera 18, the iris camera 19, the image acquisition unit 110, the score computing unit 120, the selection unit 130, the registered information database (DB) 210, the authentication unit 230, and a passport information providing unit 285 as components for realizing the functions thereof. That is, the information processing system 10 according to the thirteenth example embodiment comprises the passport information providing unit 285 instead of the information providing unit 280 and the authentication method determination unit 290 in the configuration of the twelfth example embodiment (see FIG. 28). The passport information providing unit 285 may be a processing block which is realized by, for example, the processor 11 described above (see FIG. 1).

Further, the passport information providing unit 285 may be configured as a part of the information providing unit 280 (see FIG. 28) in the twelfth example embodiment. The information processing system 10 according to the thirteenth example embodiment may also comprise the authentication method determination unit 290 described in the twelfth example embodiment (see FIG. 28).

The passport information providing unit 285 is configured so as to provide (that is, output to the outside of the system) information on the passport of the authentication target based on the authentication result of the authentication unit 230. the passport information providing unit 285 is configured so as to further provide, in addition to the passport information, information on the issuance certificate of the issuing source of the passport (e.g. information for proving to be a passport issued by the Ministry of Foreign Affairs of Japan) and information on the face of the authentication target (e.g. the face image, the feature amount extracted from the face image, and the like.). In addition, the passport information providing unit 285 may be configured to provide information on the expiration date and the like of the passport.

### (Technical Effects)

Next, technical effects obtained by the information processing system 10 according to the thirteenth example embodiment will be described.

As described in FIG. 30, in the information processing system 10 according to the thirteenth example embodiment, in addition to the passport information, the information on the issuance certificate and the information on the face of the authentication target are provided. By this way, it is possible to adequately provide information on the passport and information that may be used in conjunction therewith.

### Fourteenth Example Embodiment

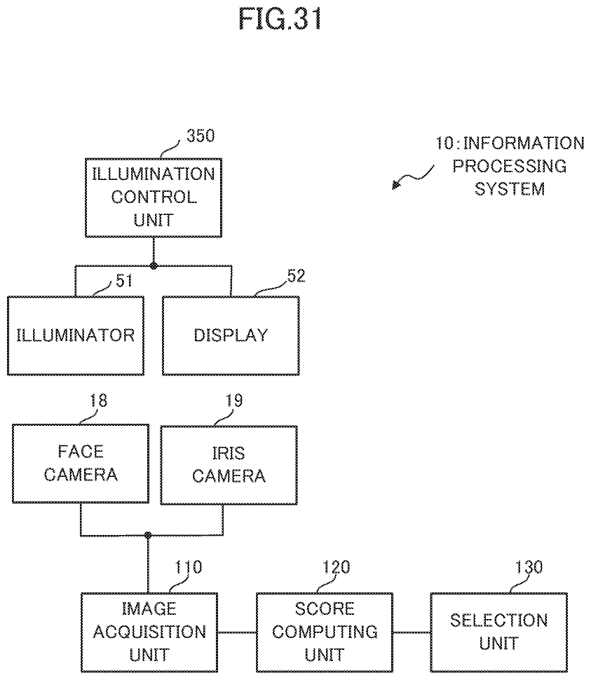

The information processing system 10 according to a fourteenth example embodiment will be described with reference to FIG. 31. The fourteenth example embodiment differs from the above-described thirteenth example embodiment only in a part of configuration and operations, and the other parts may be the same as those in the first to thirteenth example embodiments. Therefore, the part that differs from the first example embodiment described above will be described in detail below, and the other overlapping parts will not be described as appropriate.

### (Functional Configuration)

First, a functional configuration of the information processing system 10 according to the fourteenth example embodiment will be described with reference to FIG. 31. FIG. 31 is a block diagram showing the functional configuration of the information processing system according to the fourteenth example embodiment. In FIG. 30, the reference signs same as in FIG. 3 are given to the components similar to in FIG. 3 respectively.

As shown in FIG. 31, the information processing system 10 according to the fourteenth example embodiment is configured to comprise the face camera 18, the iris camera 19, the image acquisition unit 110, the score computing unit 120, the selection unit 130, and an illuminator 51, a display 52, and an illumination control unit 350 as components for realizing the functions thereof. That is, the information processing system 10 according to the fourteenth example embodiment further comprises, in addition to the configuration of the first example embodiment (see FIG. 3), the illuminator 51, the display 52, and the illumination control unit 350. Both the illuminator 51 and the display 52 may not be provided, but at least one of them may be provided. The illumination control unit 350 may be a processing block executed, for example, by the processor 11 described above (see FIG. 1).

The illuminator 51 is configured so as to emit the illumination light at the moment of imaging by the face camera 18 and the iris camera 19. The illuminator 51 may be provided, for example, in a terminal on which at least one of the face camera 18 and the iris camera 19 is mounted. The illuminator 51 may be configured as an independent illumination apparatus. The illuminator 51 according to the present example embodiment is capable of controlling the brightness (the light quantity) and the orientation.

The display 52 shows an image (e.g. an image under imaging) to the target at the moment of imaging by the face camera 18 and the iris camera 19. The display 52 may be, for example, a display provided to a terminal on which at least one of the face camera 18 and the iris camera 19 is mounted, or may be configured as an independent display apparatus. The display 52 according to the present example embodiment is capable of controlling the light quantity to be irradiated from the screen to the target. The display 52 may be capable of controlling the light quantity for each area, for example.

The illumination control unit 350 is configured so as to control at least one of the illuminator 51 and the display 52. Specifically, the illumination control unit 350 is configured so as to control at least one of the illuminator 51 and the display 52 so that the light emitted to the eyes periphery of the target varies. In particular, the illumination control unit 350 according to the present example embodiment is configured so as to control the light emitted to the eyes periphery of the target according to the distance from the eyes of the target (specifically, the distance between: the terminal on which the face camera 18 and the iris camera 19 are mounted; and the eyes of the target). For example, the illumination control unit 350 may perform control for reducing the light emitted to the eyes periphery of the target when the distance to the eyes of the target is close. In this case, the illumination control unit 350 may perform at least one of the following controls: a control for reducing the light quantity of the illuminator 51; a control for changing the orientation of the illuminator 51 in a direction away from the eyes of the target; a control for reducing the light quantity of the display 52 overall; and a control for reducing the light quantity of the area close to the eyes periphery on the display 52. Further, the illumination control unit 350 may perform control to increase the light emitted to the eyes periphery of the target when the distance to the eyes of the target is far. In this case, the illumination control unit 350 may perform at least one of the following controls: a control for increasing the light quantity of the illuminator 51; a control for changing the orientation of the illuminator 51 in a direction closer to the eyes of the target; a control for increasing the light quantity of the display 52 overall; and a control for increasing the light quantity of the area close to the eyes periphery on the display 52. The illumination control unit 350 may control at least one of the illuminator 51 and the display 52 considering the traveling direction and velocity with respect to the target or the direction and velocity with respect to move of the terminal, in addition to the distance to the eyes of the target. For example, in a case that due to the move of the target or the terminal, the distance between the eyes of the target and the terminal is changing in a direction away from each other, the illumination control unit 350 may perform control to increase the light emitted to the eyes periphery of the target. On the other hand, in a case that the distance between the eyes of the target and the terminal is changing in a direction close to each other, the illumination control unit 350 may perform control to reduce the light emitted to the eyes periphery of the target. Further, when the velocity of the target or the terminal is fast and the distance between the eyes of the target and the terminal changes rapidly, the illumination control unit 350 may perform control to change the light emitted to the eyes periphery of the target more quickly. On the other hand, when the velocity of the target or the terminal is slow and the distance between the eyes of the target and the terminal changes gradually, the illumination control unit 350 may perform to control to change the light emitted to the eyes periphery of the target slowly.

### (Technical Effects)

Next, technical effects obtained by the information processing system 10 according to the fourteenth example embodiment will be described.

As described in FIG. 31, in the information processing system 10 according to the fourteenth example embodiment, the light emitted to the eyes periphery of the target is controlled depending on the distance from the eyes of the target. By this way, it is possible to reduce the glare felt at the moment of taking an image (particularly at the moment of taking the iris image).

Also included in the scope of each example embodiment is a processing method comprising the steps of: recording in a recording medium, a computer program to operate the configuration of each above-mentioned example embodiment so as to realize the functions of each example embodiment; reading out the computer program recorded in the recording medium as code; and executing the computer program in a computer. In other words, a computer-readable recording medium is also included in the scope of each example embodiment. In addition, not only the recording medium where the above-mentioned computer program is recorded but also the computer program itself is included in each embodiment.

For example, a floppy disk (registered trademark), a hard disk, an optical disk, an optical magnetic disk, a CD-ROM, a magnetic tape, a non-volatile memory cards and a ROM can be each used as the recording medium. In addition, not only the computer program recorded on the recording medium that executes processing by itself, but also the computer program that operates on an OS to execute processing in cooperation with other software and/or expansion board functions is included in the scope of each embodiment. Further, the computer program may be stored in a server so that a part or all of the computer program can be downloaded from the server to a user terminal.

### SUPPLEMENTARY NOTE

With respect to the example embodiments described above, they may be further described as the following supplementary notes, but are not limited to the following.

### (Supplementary Note 1)

An information processing system described as the supplementary note 1 is an information processing system comprising: an image acquisition unit that acquires a face image and an iris image with respect to a registration target; a score computing unit that calculates a quality-score indicating quality with respect to each of the face image and the iris image; and a selection unit that selects each of the face image and the iris image for registration based on the quality-score.

### (Supplementary Note 2)

An information processing system described as the supplementary note 2 is the information processing system according to the supplementary note 1, further comprising: a mode change unit that switches based on a size of eyes of the registration target, between a first mode where imaging of the face image and the iris image is executed in parallel with calculation of the quality-scores and a second mode where the calculation of the quality-scores is executed after the imaging of the face image and the iris image; and a threshold change unit that changes based on the size of eyes of the registration target, a threshold of the quality-score to be used at a moment when the selection unit selects the face image and the iris image to be registered.

### (Supplementary Note 3)

An information processing system described as the supplementary note 3 is the information processing system according to the supplementary note 1 or 2, further comprising an order output unit that, in a case that at least one of the face image and the iris image to be used for authentication includes a plurality of authentication targets, outputs information indicating an order of each of the plurality of authentication targets for authentication, the information being displayed in a superimposed manner on a screen where the plurality of authentication targets are captured.

### (Supplementary Note 4)

An information processing system described as the supplementary note 4 is the information processing system according to any one of the supplementary notes 1 to 3, further comprising: a prediction unit that predicts, based on a direction from an authentication target to an iris camera and a velocity of the authentication target, a position of an iris of the authentication target at a moment when the iris image is taken; and an iris camera adjustment unit that adjusts an angle of view of the iris camera based on the position of the iris predicted.

### (Supplementary Note 5)

An information processing system described as the supplementary note 5 is the information processing system according to any one of the supplementary notes 1 to 4, further comprising an iris image specifying unit that specifies out of more than one of the iris image, an iris image where no eyelashes cover an iris, and outputs the image as the iris image to be used for authentication.

### (Supplementary Note 6)

An information processing system described as the supplementary note 6 is the information processing system, according to any one of the supplementary notes 1 to 5, further comprising an iris image complement unit that complements an area covered by eyelashes by synthesizing more than one of the iris image where the eyelashes cover an iris, and outputs an image obtained by the complement as an image to be used for authentication.

### (Supplementary Note 7)

An information processing system described as the supplementary note 7 is the information processing system, according to any one of the supplementary notes 1 to 6, wherein the image acquisition unit acquires the face image and the iris image with respect to a first authentication target, and the face image and the iris image with respect to a second authentication target, and wherein the information processing system further comprises: a first application that performs authentication using the face image and the iris image with respect to the first authentication target; a second application that performs authentication using the face image and the iris image with respect to the second authentication target; and a parallel authentication unit that makes the first application and the second application operate in parallel with each other to control authentication with respect to each of the first authentication target and the second authentication target.

### (Supplementary Note 8)

An information processing system described as the supplementary note 8 is the information processing system according to the supplementary note 7, wherein the parallel authentication unit performs the authentication on the first authentication target by using the face image and a single-eye image with respect to the first authentication target, and performs the authentication on the second authentication target by using the face image and a single-eye image with respect to the second authentication target.

### (Supplementary Note 9)

An information processing system described as the supplementary note 9 is the image processing system according to any one of claims 1 to 8, further comprising: a superimposed display unit that displays in a superimposed manner a first mark at an eyes periphery of the registration target after taking the face image of the registration target, and also displays in a superimposed manner a second mark indicating a size of the eyes periphery suitable for taking the iris image; and an imaging control unit that executes control so that the iris image of the registration target is taken at a moment when the first mark overlaps the second mark.

### (Supplementary Note 10)

An information processing system described as the supplementary note 10 is the information processing system according to any one of the supplementary notes 1 to 9, further comprising: a first registration control unit that, in a case that the quality-score of the iris image taken by a first terminal is equal to or less than a predetermined threshold, or the iris image is impossible to be taken, executes control so that only the face image taken by the first terminal is registered; and a second registration control unit that, in a case that the iris image of an authentication target is not registered at a moment when authentication is performed using the face image by a second terminal, executes control so that the iris image is taken and registered by the second terminal.

### (Supplementary Note 11)

An information processing system described as the supplementary note 11 is the information processing system according to any one of the supplementary notes 1 to 10, further comprising an impersonation detection unit that detects impersonation when detecting at least predetermined difference by comparing an iris area included in the face image to the iris image.

### (Supplementary Note 12)

An information processing system described as the supplementary note 12 is the information processing system according to any one of the supplementary notes 1 to 11, further comprising: an information providing unit that provides information on an authentication target based on a result of authentication using the face image and the iris image; and a determination unit that determines based on a kind with respect to the information to be provided, which image is used for the authentication; only the face image, only the iris image, or both the face image and the iris image.

### (Supplementary Note 13)

An information processing system described as the supplementary note 13 is the information processing system according to any one of the supplementary notes 1 to 12, further comprising a passport information providing unit that provides information on a passport of an authentication target based on a result of authentication using the face image and the iris image, wherein the passport information providing unit further provides, in addition to the information on the passport, information on an issuance certificate of an issuing source of the passport and information on a face of the authentication target.

### (Supplementary Note 14)

An information processing system described as the supplementary note 14 is the information processing system according to any one of the supplementary notes 1 to 13, further comprising an illumination control unit that controls, at a moment when the face image and the iris image are taken by a terminal, at least one of an illuminator and a display of the terminal, according to a distance between the terminal and eyes, and a moving velocity of the registration target, an authentication target, or the terminal.

### (Supplementary Note 15)

An information processing apparatus described as the supplementary note 15 is an information processing apparatus comprising: an image acquisition unit that acquires a face image and an iris image with respect to a registration target; a score computing unit that calculates a quality-score indicating quality with respect to each of the face image and the iris image; and a selection unit that selects each of the face image and the iris image for registration based on the quality-score.

### (Supplementary Note 16)

An information processing method described as the supplementary note 16 is an information processing method executed by at least one computer, comprising: acquiring a face image and an iris image with respect to a registration target; calculating a quality-score indicating quality with respect to each of the face image and the iris image; and selecting each of the face image and the iris image for registration based on the quality-score.

### (Supplementary Note 17)

A recording medium described as the supplementary note 17 is a recording medium storing a computer program that allows at least one computer to execute an information processing method, the information processing method comprising: acquiring a face image and an iris image with respect to a registration target; calculating a quality-score indicating quality with respect to each of the face image and the iris image; and selecting each of the face image and the iris image for registration based on the quality-score.

### (Supplementary Note 18)

A computer program described as the supplementary note 18 is a computer program that allows at least one computer to execute an information processing method, the information processing method comprising: acquiring a face image and an iris image with respect to a registration target; calculating a quality-score indicating quality with respect to each of the face image and the iris image; and selecting each of the face image and the iris image for registration based on the quality-score.

The disclosures can be modified as necessary to the extent that does not contradict the concept of idea of the invention that can be read from the entire claims and the entire description. Information processing systems, information processing apparatuses, information processing methods, and recording media with such modifications are also included in the technical concept of this disclosure.

### DESCRIPTION OF REFERENCE SIGNS

10 Information Processing System
11 Processor
18 Face Camera
19 Iris Camera
30 Authentication Terminal
35 Camera Installation Portion
40 Display
51 Illuminator
52 Display
110 Image Acquisition Unit
115 Target Position Detection Unit
116 Rotation Control Unit
120 Score Computing Unit
130 Selection Unit
140 Mode Switch Unit
150 Threshold Change Unit
210 Registered Information Database
220 Order Output Unit
230 Authentication Unit
231 First Authentication App
232 Second Authentication App
240 Iris Image Specifying Unit
245 Iris Image Complement Unit
250 First Registration Control Unit
260 Second Registration Control Unit
270 Impersonation Detection Unit
280 Information Providing Unit
285 Passport Information Providing Unit
290 Authentication Method Determination Unit
310 Iris Position Prediction Unit
320 Iris Camera Adjustment Unit
330 Superimposed Display Unit
340 Imaging Control Unit
350 Illumination Control Unit

What is claimed is:

1. An information processing system comprising:
at least one memory configured to store instructions; and
at least one processor configured to execute the instructions to:
acquire a face image and an iris image with respect to a registration target;
calculate a quality-score indicating quality with respect to each of the face image and the iris image; and
select each of the face image and the iris image for registration based on the quality-score.

2. The information processing system according to claim 1, wherein
the at least one processor is further configured to execute the instructions to:
switch based on a size of eyes of the registration target, between a first mode where imaging of the face image and the iris image is executed in parallel with calculation of the quality-scores and a second mode where the calculation of the quality-scores is executed after the imaging of the face image and the iris image; and
change based on the size of eyes of the registration target, a threshold of the quality-score to be used at a moment when the selection unit selects the face image and the iris image to be registered.

3. The information processing system according to claim 1, wherein
the at least one processor is further configured to execute the instructions to
in a case that at least one of the face image and the iris image to be used for authentication includes a plurality of authentication targets, output information indicating an order of each of the plurality of authentication targets for authentication, the information being displayed in a superimposed manner on a screen where the plurality of authentication targets are captured.

4. The information processing system according to claim 1, wherein
the at least one processor is further configured to execute the instructions to:
predict, based on a direction from an authentication target to an iris camera and a velocity of the authentication target, a position of an iris of the authentication target at a moment when the iris image is taken; and
adjust an angle of view of the iris camera based on the position of the iris predicted.

5. The information processing system according to claim 1, wherein
the at least one processor is further configured to execute the instructions to
specify out of more than one of the iris image, an iris image where no eyelashes cover an iris, and output the image as the iris image to be used for authentication.

6. The information processing system, according to claim 1, wherein
the at least one processor is further configured to execute the instructions to
complement an area covered by eyelashes by synthesizing more than one of the iris image where the eyelashes cover an iris, and output an image obtained by the complement as an image to be used for authentication.

7. The information processing system, according to claim 1, wherein
the at least one processor is further configured to execute the instructions to
acquire the face image and the iris image with respect to a first authentication target, and the face image and the iris image with respect to a second authentication target, and wherein
the at least one processor is further configured to execute the instructions to:
perform authentication using the face image and the iris image with respect to the first authentication target as a first application;
perform authentication using the face image and the iris image with respect to the second authentication target as a second application; and
make the first application and the second application operate in parallel with each other to control authentication with respect to each of the first authentication target and the second authentication target.

8. The information processing system according to claim 7, wherein
the at least one processor is further configured to execute the instructions to
perform the authentication on the first authentication target by using the face image and a single-eye image with respect to the first authentication target, and perform the authentication on the second authentication target by using the face image and a single-eye image with respect to the second authentication target.

9. The image processing system according to claim 1, wherein
the at least one processor is further configured to execute the instructions to:
display in a superimposed manner a first mark at an eyes periphery of the registration target after taking the face image of the registration target, and also display in a superimposed manner a second mark indicating a size of the eyes periphery suitable for taking the iris image; and
execute control so that the iris image of the registration target is taken at a moment when the first mark overlaps the second mark.

10. The information processing system according to claim 1, wherein
the at least one processor is further configured to execute the instructions to
in a case that the quality-score of the iris image taken by a first terminal is equal to or less than a predetermined threshold, or the iris image is impossible to be taken, execute control so that only the face image taken by the first terminal is registered; and
in a case that the iris image of an authentication target is not registered at a moment when authentication is performed using the face image by a second terminal, execute control so that the iris image is taken and registered by the second terminal.

11. The information processing system according to claim 1, wherein
the at least one processor is further configured to execute the instructions to
detect impersonation when detecting at least predetermined difference by comparing an iris area included in the face image to the iris image.

12. The information processing system according to claim 1, wherein
the at least one processor is further configured to execute the instructions to:
provide information on an authentication target based on a result of authentication using the face image and the iris image; and
determine based on a kind with respect to the information to be provided, which image is used for the authentication; only the face image, only the iris image, or both the face image and the iris image.

13. The information processing system according to claim 1, wherein
the at least one processor is further configured to execute the instructions to
provide information on a passport of an authentication target based on a result of authentication using the face image and the iris image, and wherein
the at least one processor is further configured to execute the instructions to
further provide, in addition to the information on the passport, information on an issuance certificate of an issuing source of the passport and information on a face of the authentication target.

14. The information processing system according to claim 1, wherein
the at least one processor is further configured to execute the instructions to
control at a moment when the face image and the iris image are taken by a terminal, at least one of an illuminator and a display of the terminal, according to a distance between the terminal and eyes, and a moving velocity of the registration target, an authentication target, or the terminal.

15. (canceled)

16. An information processing method executed by at least one computer, comprising:
acquiring a face image and an iris image with respect to a registration target;
calculating a quality-score indicating quality with respect to each of the face image and the iris image; and
selecting each of the face image and the iris image for registration based on the quality-score.

17. A non-transitory recording medium storing a computer program that allows at least one computer to execute an information processing method, the information processing method comprising:
acquiring a face image and an iris image with respect to a registration target;
calculating a quality-score indicating quality with respect to each of the face image and the iris image; and
selecting each of the face image and the iris image for registration based on the quality-score.
